(19) United States
(12) Patent Application Publication
(10) Pub. No.: US 2003/0201419 A1
(43) Pub. Date: Oct. 30, 2003

(54) Fire-extinguishing chemical

(76) Inventors: Kazunori Tanaka, Osaka (JP); Kenji Nagao, Nara-ken (JP); Yutaka Hashimoto, Osaka (JP)

Correspondence Address: ARMSTRONG,WESTERMAN & HATTORI, LLP, 1725 K STREET, NW, SUITE 1000, WASHINGTON, DC, 20006, US

(21) Appl. No.: 10/257,988

(22) PCT Filed: Apr. 26, 2001
(86) PCT No.: PCT/JP01/03608

(30) Foreign Application Priority Data
May 2, 2000 (JP) 2000-133406

(51) Int. Cl. A62C 2/00; A62D 1/00

(52) U.S. Cl. 252/3

(57) ABSTRACT

The present invention provides a fire extinguishing composition which is superior in rapid fire extinguishing performance, flame resistance, fuel resistance, re-ignition preventive performance and dilution stability to a conventional fire extinguishing composition against both fires of non-polar solvents and fires of polar solvents. This fire extinguishing composition contains a cationic polyamine-based polymeric compound (A), and the viscosity at 25° C. of an aqueous solution containing 50% by weight of the cationic polyamine-based polymeric compound (A) is from 10,000 to 30,000 mPa·s.

### TECHNICAL FIELD

The present invention relates to a fire extinguishing composition containing a cationic polyamine-based polymeric compound, which is superior in rapid fire extinguishing performance, flame resistance, fuel resistance, and re-ignition preventive performance.

### BACKGROUND ART

In the case of fires of polar solvents such as alcohol, ketone, ester, ether, and amine, even if attempts are made to extinguish fire is made by using a conventional fire extinguishing composition for petroleum fires, defoaming occurs immediately after contact with the burning liquid surface, thus making it impossible to extinguish the fire. Therefore, there have hitherto been proposed, as fire extinguishing compositions for polar solvents,

(1) a fire extinguishing composition prepared by adding a metal soap to a protein hydrolysate,

(2) a fire extinguishing composition prepared by adding a metal soap to a synthetic surfactant,

(3) a fire extinguishing composition prepared by adding a fluorine type surfactant to a protein hydrolysate (protein fluoride), and

(4) a fire extinguishing composition prepared by adding a water-soluble polymeric substance to a fluorine type surfactant to form a thixotropic liquid.

Among these, the fire extinguishing composition (4) is a fire extinguishing composition prepared by adding a water-soluble polymeric substance (for example, polysaccharides) to an aqueous film forming foam-type fire extinguishing composition containing a fluorine type surfactant as a base, to thereby impart thixotropy. It is believed that this composition is dehydrated at the interface when contacted with a polar solvent to form a water-soluble polymeric substance containing air bubbles on the surface of the solvent, and thus making it possible to prevent the foams from directly contacting with the solvent and to spread over the liquid surface, resulting in fire extinguishing due to cooling and smothering. As compared with the fire extinguishing compositions (1), (2) and (3), the fire extinguishing composition (4) has good spreadability on a burning liquid surface and also has an improved fire extinguishing effect.

However, as will be anticipated from the mechanism by which the foams are protected by a gel-like mat of a thixotropic water-soluble polymeric substance, this fire extinguishing composition has a reduced fire extinguishing effect against fires of solvents having high volatility or generating high heat of combustion, such as alcohols (e.g., isopropanol, t-butanol, etc.), propylene oxide, etc., which leads to difficult handing. Furthermore, the fire extinguishing composition (4) exerts an effect in a system of gently placing foams on the oil surface along the wall surface of the tank like a foam chamber, namely, so-called soft running system, because it performs fire extinction by smothering utilizing a masking effect due to the gel-like mat. On the other hand, in a system of directly discharging over the oil surface using a foam spray nozzle of a fire engine for composition fire as an exclusive means of a fire extinguishing strategy, waving of the oil surface and sinking of the gel-like mat occur and the oil surface appears again to cause ignition again. Therefore, there still remain some problems in performance at the site of practical fire extinguishing.

Also since this fire extinguishing composition contains a large amount of a water-soluble polymeric substance, an undiluted solution of the composition has a very high viscosity (1200 mm²/s or more) and the viscosity varies greatly with the temperature. Therefore, special attention must be paid to fire extinguishing equipment (for example, mixer or piping) and this tends to cause difficult handling in practical applications. Furthermore, the fire extinguishing composition cannot withstand storage for a long period of time because a thin layer (skin) of it is likely to form on the wall surface of the tank and the liquid surface and a resinous precipitate is formed on the bottom of the tank during storage. Furthermore, this fire extinguishing composition has a freezing temperature of as high as about 0° C. and does not have reversibility between freezing and melting. For this reason, special considerations are required in using or storing it in cold climate areas.

The present inventors have conducted extensive research in order to solve the above problems, and disclosed a fire extinguishing composition comprising an anionic hydrophilic group-containing surfactant, a cationic water-soluble polymeric compound and a polybasic acid compound having 3 to 24 carbon atoms as a third component, which is superior in fuel resistance, flame resistance (for example, re-ignition sealing property) and heat resistance to a conventional fire extinguishing composition (see Japanese Examined Patent Application, Second Publication No. Hei 1-12503).

This fire extinguishing composition can extinguish both fire of polar solvents and fires of non-polar solvents, but is not superior in rapid fire extinguishing performance because it requires a long time to extinguish fire, and is also inferior in flame resistance and re-ignition preventive performance. In the case in which the fire extinguishing composition is diluted with fresh water or sea water when used in actual fire fighting, turbidity is produced in the dilute solution. Therefore, the fire extinguishing composition is inferior in dilute solution stability.

### DISCLOSURE OF INVENTION

An object of the present invention is to provide a fire extinguishing composition which is superior in rapid fire extinguishing performance, flame resistance, fuel resistance, re-ignition preventive performance and dilute solution stability against both fires of non-polar solvents and fires of polar solvents compared to conventional fire extinguishing compositions.

The present inventors have performed extensive research in order to solve the above problems. As a result, they have focused attention to the viscosity of the above aqueous cationic water-soluble polymeric compound solution and found that an aqueous compound solution having a specific viscosity exhibits improved fire extinguishing performance, fuel resistance, flame resistance, and heat resistance, thus completing the present invention.

That is, the present invention provides [I] a fire extinguishing composition comprising a cationic polyamine-based polymeric compound (A), wherein a viscosity at 25° C. of an aqueous solution containing 50% by weight of the cationic polyamine-based polymeric compound (A) is from 10,000 to 30,000 mPa·s;

[II] the fire extinguishing composition described in [I], which contains an anionic hydrophilic group-containing surfactant (B);

[III] the fire extinguishing composition described in [I] or [II], which contains a polybasic acid compound (C).

[IV] the fire extinguishing composition described in any one of [I] to [III], wherein the cationic polyamine-based polymeric substance (A) is polyethyleneimine or a derivative thereof;

[V] the fire extinguishing composition described in any one of [I] to [IV], wherein the polybasic acid compound (C) is a dibasic acid compound having 4 to 18 carbon atoms; and

[VI] the fire extinguishing composition described in any one of [I] to [V], wherein the anionic hydrophilic group-containing surfactant (B) is a fluorine-containing type surfactant having a fluorinated aliphatic group having 3 to 20 carbon atoms as a hydrophobic group.

Unlike the fire extinguishing composition (4), the fire extinguishing compositions of the present invention can perform fire extinguishing using any fire extinguishing means because it enables fire extinguishing using gel-like foams. Unlike the fire extinguishing composition described in Japanese Examined Patent Application, Second Publication No. Hei 1-12503, the fire extinguishing composition of the present invention is characterized by improved fire extinguishing performance and good dilute solution stability.

### BEST MODE FOR CARRYING OUT THE INVENTION

The cationic polyamine-based polymeric compound (A) used in the present invention refers to a polymeric compound having a cationic group such as an amino group, ammonium group, pyridinium group or quaternary ammonium group, and is usually a water-soluble polymeric compound having a solubility in water of 50% by weight or more.

The cationic group includes primary, secondary and tertiary cationic groups and these cationic groups may be present on a main chain or a side chain of a polyamine-based polymeric compound.

Although each ratio of primary, secondary and tertiary cationic groups to the cationic group is not specifically limited, it is necessary that the ratio of the primary cationic group be 40% by weight or less based on the total of the cationic groups, in the present invention.

The polymerization degree of the water-soluble polymeric compound is dependent on the solubility in water, and the water-soluble polymeric compounds include compounds having a polymerization degree in the range of from an oligomer level to a polymerization degree of tens of thousands. Among these compounds, the number-average molecular weight of the compound is preferably from about 1,000 to 1,000,000, more preferably from 4,000 to 300,000, and most preferably from 50,000 to 100,000 in view of fire extinguishing performance on polar solvents, flame resistance and fuel resistance.

Specific examples of the cationic polyamine-based polymeric compound (A) include, but are not limited to, those described below, and the present invention is not limited to the followings specific examples.

A-I: polyethyleneimine

A-II: N-substituted compound polyethyleneimine

N-substituted compound includes, for example, —CₙH₂ₙ₊₁, —CONHCₙH₂ₙ₊₁, —COCₙH₂ₙ₊₁ or —(CH₂CH₂O)ₙ—H (provided that n represents an integer of 1 to 6).

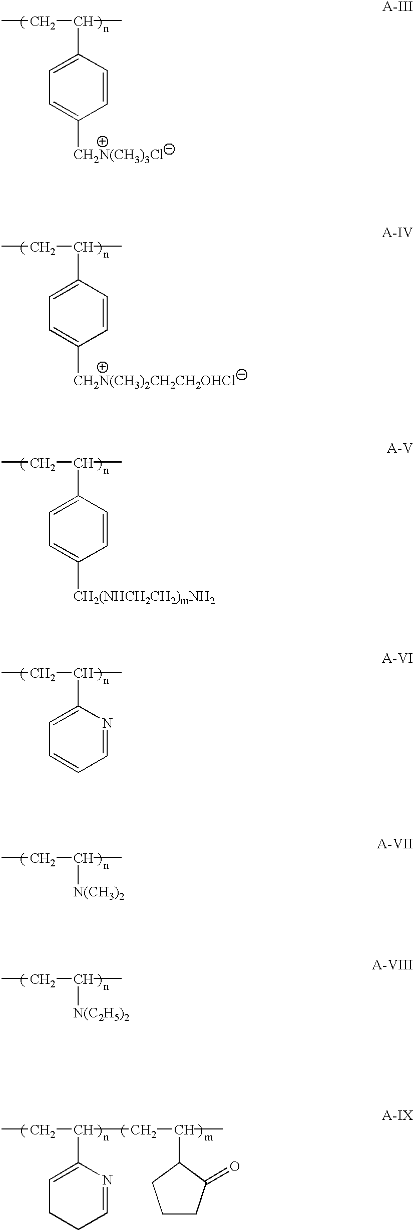

(In A-III to A-IX, n and m each represents a positive integer.)

A-X: melamine-formaldehyde condensate

A-XI: guanidine-formaldehyde condensate

It is necessary that the fire extinguishing composition of the present invention not only generate performances required as a foam-type fire extinguishing composition, such as rapid fire extinguishing performance, flame resistance, and ability to maintain foams on the liquid surfaces of water-insoluble flammable substances and water-soluble flammable substances, namely, fuel resistance, but also satisfies basic properties such as specific gravity, pour point, viscosity, hydrogen ion concentration, amount of the precipitate and corrosiveness as stipulated in Government Inspection Regulations based on Ministerial Ordinance Stipulating Technical Standards of Foam-type Fire Extinguishing Compositions of Japan, established on Dec. 9, 1975 (Ordinance No. 26 of the Ministry of Home Affairs of Japan). Therefore, in order to reconcile fire extinguishing performance and basic performances, various additives such as additional foam stabilizers, freezing point depressants, rust preventives and pH adjustors are mixed therein as components of the foam-type fire extinguishing composition, in addition to the main component, at present.

As the main component of the foam-type fire extinguishing composition suited for use under these circumstances, various cationic polyamine-based polymeric compounds can be used as described above. As described above, it is necessary to use a cationic polyamine-based polymeric compound wherein a viscosity at 25° C. of a 50 wt % aqueous solution is from 10,000 to 30,000 mPa·s.

When using the cationic polyamine-based polymeric compound wherein the viscosity at 25° C. of the aqueous solution exceeds 30,000 mpa·s, not only does the viscosity of an undiluted solution of the foam-type fire extinguishing composition not meet the technical standard of Ordinance No. 26 of the Ministry of Home Affairs of Japan, but also the rate of mixing with water is slow because of an increase in viscosity of the undiluted solution of the foam-type fire extinguishing composition in actual fire fighting, and is thus likely to cause problems such as prolongation of the fire extinguishing time due to spraying in a nonuniform state. On the other hand, when using a cationic polyamine-based polymeric compound wherein the viscosity at 25° C. of the aqueous solution is less than 10,000 mpa·s, a precipitate is produced in an aqueous solution prepared by mixing 97 parts by weight or 94 parts by weight of fresh water or sea water with 3 parts by weight or 6 parts by weight of an undiluted solution of the foam-type fire extinguishing composition, there arise not only a problem that the dilute solution stability does not meet the amount of the precipitate of the dilute solution as one item of the technical standard of Ordinance No. 26 of the Ministry of Home Affairs of Japan, but also there arises an unexpected situation in that clogging of the tips of various nozzles used in actual fire fighting by precipitates occurs in actual fire fighting.

With respect to the fire extinguishing performance, more excellent properties in rapid fire extinguishing performance, flame resistance, fuel resistance, and re-ignition preventive performance are imparted by using the cationic polyamine-based polymeric compound wherein a viscosity at 25° C. of a 50 wt % aqueous solution is from 10,000 to 30,000 mPa·s.

Taking into account the compatibility with various additives such as additional foam stabilizers, freezing point depressants, rust preventives and pH adjustors, cost advantages, safety to humans and the environment, availability of raw materials, polyethyleneimine or partially modified polyethyleneimine is preferably used as the cationic polyamine-based polymeric compound.

The viscosity at 25° C. of the aqueous solution containing 50% by weight of the cationic polyamine-based polymeric compound in the present invention can be measured by a BM type rotary viscometer under the conditions of a rotor No. 3 and a rate of revolution of 6 rpm.

The method of preparing the cationic polyamine-based polymeric compound of the present invention is not specifically limited and includes, for example, a method of subjecting monoethanolamine to direct dehydration ring-opening in a vapor phase in the presence of a solid acid-base catalyst, thereby to synthesize ethyleneimine and subjecting the resulting ethyleneimine to ring-opening polymerization in the presence of an acid catalyst, thereby to synthesize polyethyleneimine. The resulting polyethyleneimine is not a complete linear polymer in reaction kinetics but, as shown in the following reaction scheme, a polymeric compound having a branched structure including primary, secondary and tertiary amines is obtained. The acid catalyst used in the ring-opening polymerization of ethyleneimine may be any of a mineral acid, inorganic or organic metal-based Lewis acid. The branched structure varies depending on the catalyst used, and therefore compounds having different ratios of primary, secondary and tertiary amines in a molecule can be obtained.

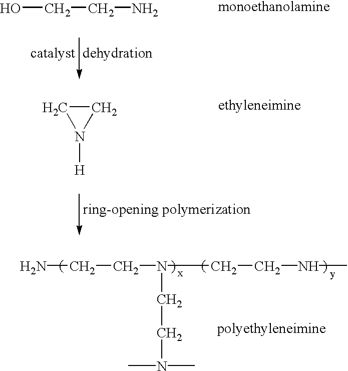

To the fire extinguishing composition of the present invention, an anionic hydrophilic group-containing surfactant (B) is preferably added in view of improvement in fuel resistance. The anionic hydrophilic group-containing surfactant (B) used in the present invention enables electrostatic interaction with the cationic polyamine-based polymeric compound (A). In this respect, it is necessary that the surfactant be a compound having at least one anionic hydrophilic group.

The anionic hydrophilic group is preferably a group such as —COOH, —SO₃H, —OSO₃H or —OP(OH)₂, and particularly preferably —SO₃H. The counter ion of the cationic group may have an organic or inorganic anionic group.

The surfactant may have the same or different kinds of one or more anionic groups as the hydrophilic group and may be an amphoteric surfactant having a cationic hydrophilic group and/or a nonionic group, in addition to the anionic hydrophilic group. Among these surfactants, the amphoteric surfactant is preferred in view of the compatibility.

Examples of the hydrophobic group of the surfactant include aliphatic hydrocarbon group having 6 or more carbon atoms, dihydrocarbylsiloxane chain, and fluorinated aliphatic hydrocarbon group having 3 to 20 carbon atoms, and preferably 6 to 16 carbon atoms. Among these groups, a fluorinated aliphatic group is particularly preferred in view of an improvement in fuel resistance. The surfactant may be a surfactant prepared by mixing a surfactant having an anionic hydrophilic group with a compound having a hydrophobic group.

Specific examples of the anionic hydrophilic group-containing surfactant (B), which is particularly useful in the present invention include surfactants (B-1) to (B-11).

(B-1) Fluorine-Containing Amino Acid Type Amphoteric Surfactant

Fluorine-containing amino acid type amphoteric surfactant represented by the general formula:

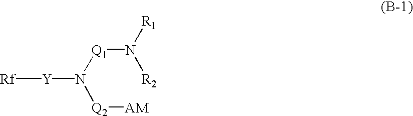

[wherein Rf represents a fluorinated aliphatic group having 3 to 20 carbon atoms, Y represents —SO₂— or —CO, Q₁ and Q₂ represent an organic divalent linking group and include, for example, an aliphatic hydrocarbon group, an aliphatic hydrocarbon group substituted with a hydroxy group, an aromatic hydrocarbon group, a substituted aromatic hydrocarbon group, or a combination thereof, and preferably —(CH₂)—ⱼ (j represents an integer of 1 to 6),

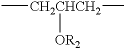

(R₂ represents a hydrogen atom or an alkyl group having 1 to 3 carbon atoms), R₁ and R₂ represent a hydrogen atom, or an aliphatic hydrocarbon group substituted with an aliphatic hydrocarbon group having 1 to 12 carbon atoms or a hydrophilic group, or R₁ and R₂ are combined together with adjacent nitrogen atoms to form a ring, A represents an anionic hydrophilic group and includes, for example, —COO⁻, —SO₃⁻, OSO₃⁻ or —OP(OH)O⁻, M represents a hydrogen atom, an alkali metal, an alkali earth metal, an ammonium group or an organic cationic group].

Specific examples of the compound are listed below, but the present invention is not limited to the following specific examples.

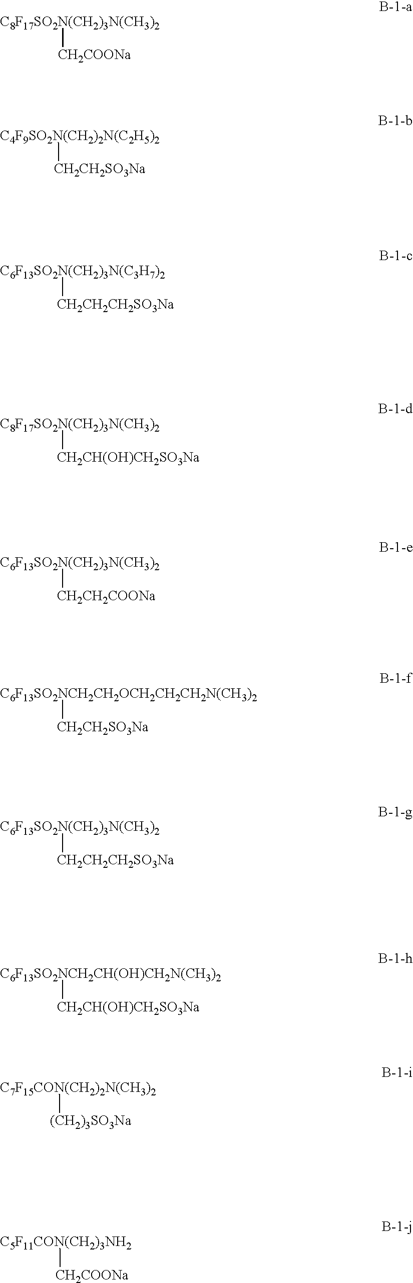

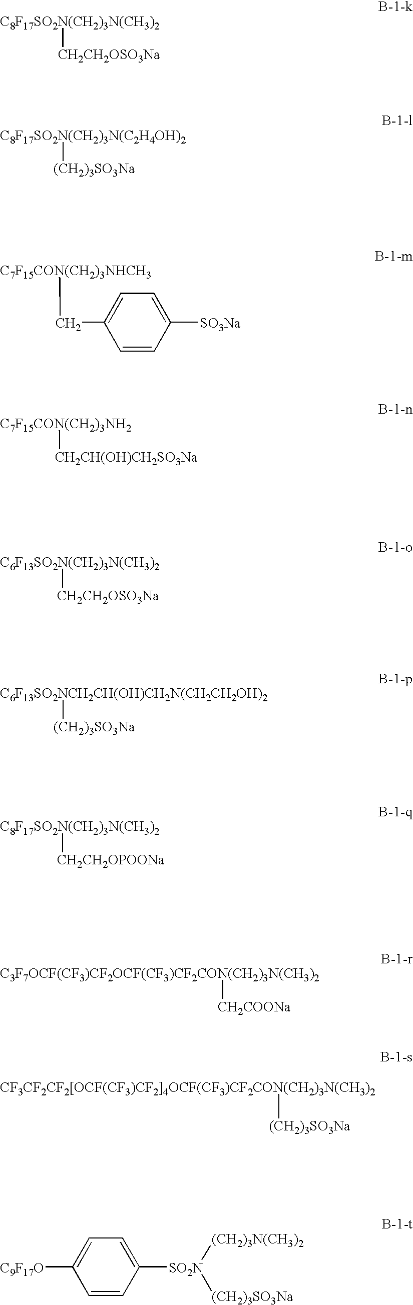

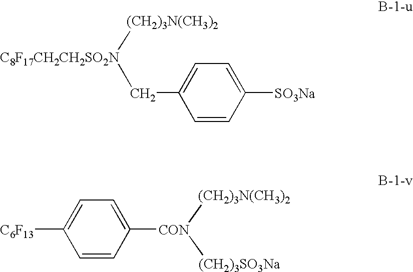

(B-2) Fluorine-Containing Aminosulfonate Type Surfactant Fluorine-Containing Aminosulfonate Type Surfactant Represented by the General Formula:

Rf-Z-Q₁—N(R)-Q₂-SO₂M (B-2)

[wherein Rf represents a group having a fluorinated aliphatic group having 3 to 20 carbon atoms, Z represents a divalent linking group and includes, for example, —SO₂N(R₁)—, —CON(R₁)—(CH₂ CH₂) i SO₂ N(R₁)—,

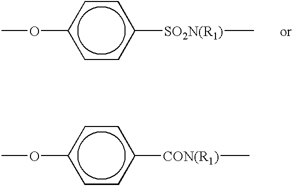

(provided that R₁ represents a hydrogen atom or an alkyl group having 1 to 12 carbon atoms and i represents an integer of 1 to 10),

Q, represents —(CH₂)ⱼ— (j represents an integer of 1 to 6) or

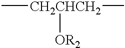

(provided that R₂ represents a hydrogen atom or an alkyl group having 2 to 3 carbon atoms),

R represents a hydrogen atom, an alkyl or hydroxyalkyl group having 1 to 3 carbon atoms, -Q₂SO₃M, or —(CH₂)ₖCOOM (provided that, k represents an integer of 1 to 4), Q₂ represents —(CH₂)₁— (1 represents an integer of 1 to 4),

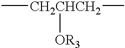

(R₃ represents a hydrogen atom or an alkyl group having 2 to 3 carbon atoms) or,

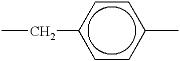

M represents a cationic atom or atomic group, a hydrogen atom, an alkali metal, an alkali earth metal or N(H)ₘ(R₄)ₙ (provided that R₄ represents an alkyl group having 1 to 3 carbon atoms or a hydroxyalkyl group, and m and n represent an integer of 0 to 4 and satisfy the equation: m+n=4)].

Specific examples of the compound are listed below, but the present invention is not limited to the following specific examples.

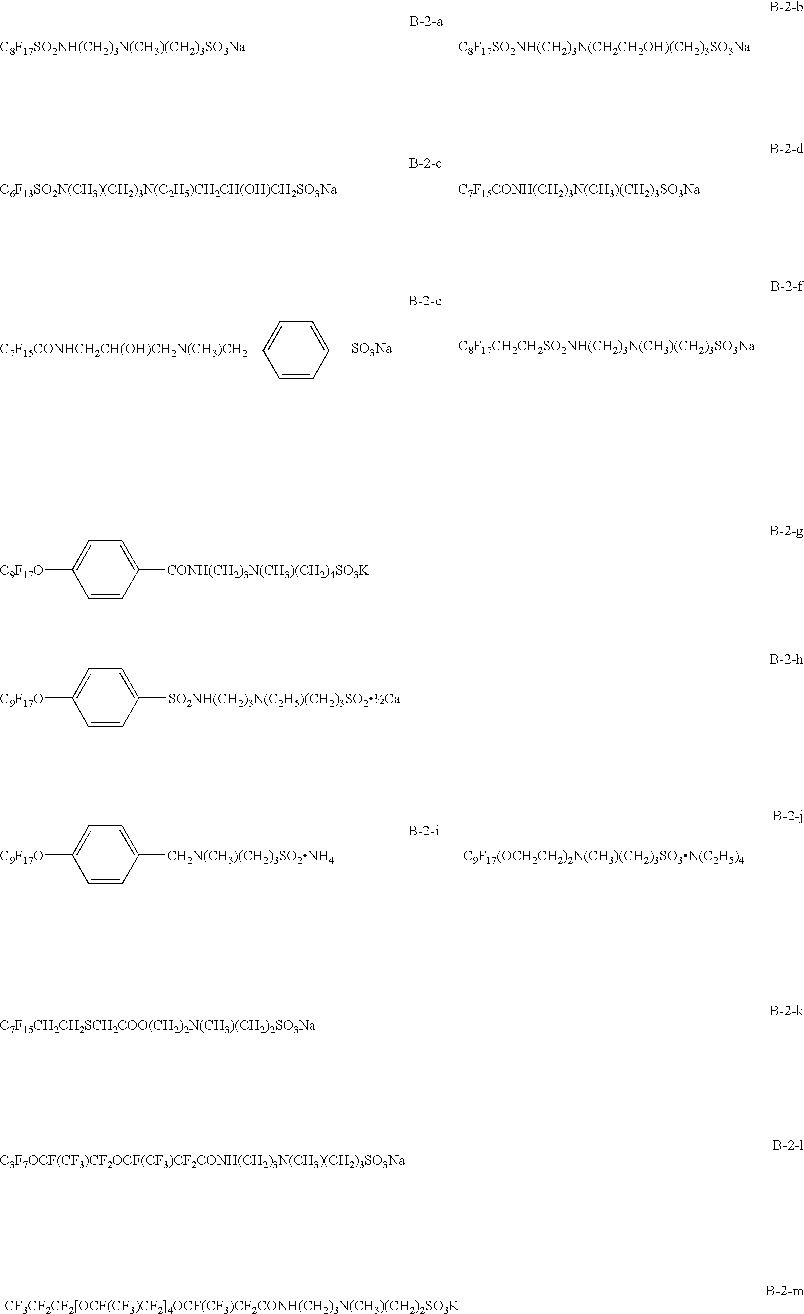

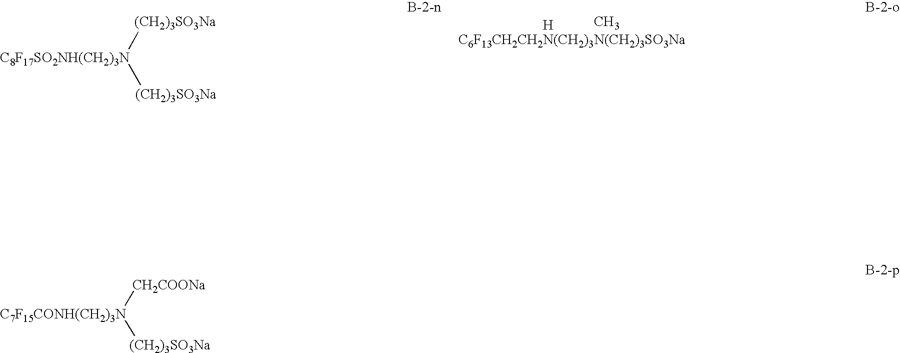

(B-3) Fluorine-Containing Aminocarboxylate Type Surfactant Fluorine-Containing Aminocarboxylate Type Surfactant Represented by the General Formula:

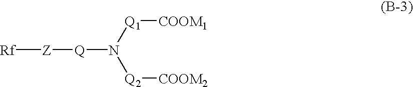

[wherein Rf represents a polyfluoroalkyl group having 3 to 20 carbon atoms, a polyfluoroalkenyl group, a polyfluorocyclohexyl group, a polyfluorocyclohexyl.alkyl group or a polyfluorocyclohexyl.alkenyl group, Z represents a divalent linking group of:

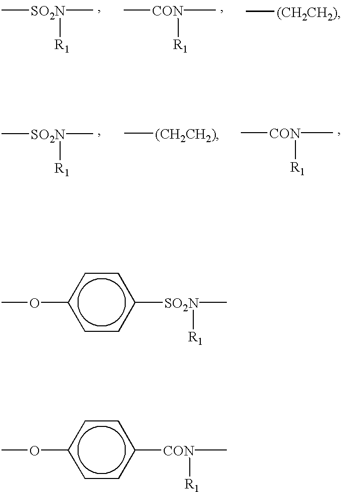

[provided that R₁ represents an alkyl group having 1 to 18 carbon atoms, an alkenyl group, or monovalent group having an aromatic ring, and i represents an integer of 1 to 3], Q represents a divalent linking group of: 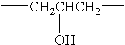 —(CH₂)_{l—, —(CH}₂)ₘ—O—(CH₂)ₙ—

or

—(CH₂)ₚ—O—(CH₂)₂—O—(CH₂)_{q}—

[provided that l represents an integer of 1 to 6, m and n each represents an integer of 2 to 6, and p and q each represents 2 or 3], Q₁ and Q₂ each represents a divalent linking group of:

—(CH₂)ᵣ—

[provided that r represents an integer of 1 to 3], and M₁ and M₂ each represents a hydrogen atom, or an inorganic or organic cation].

Specific examples of the compound are listed below, but the present invention is not limited to the following specific examples.

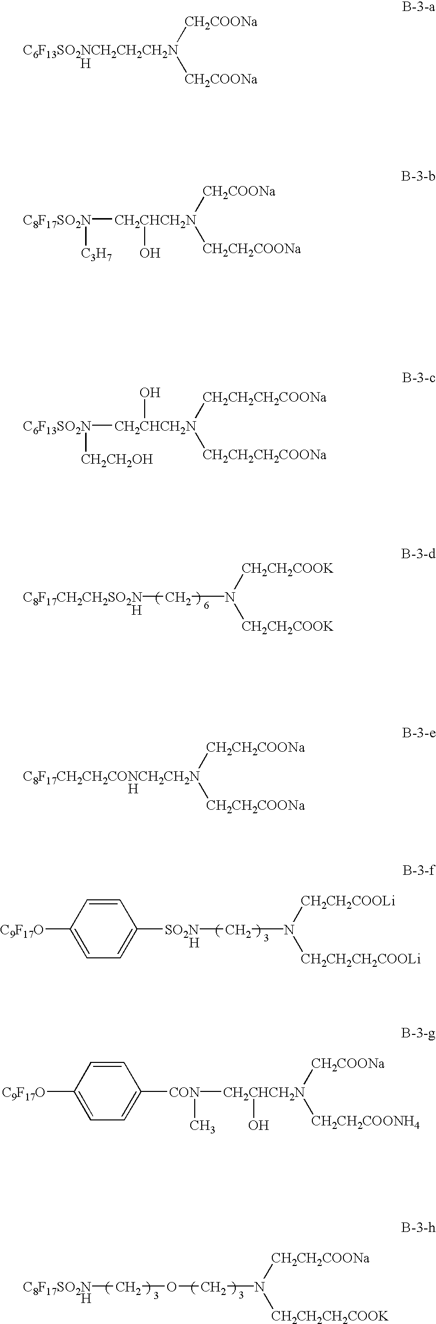

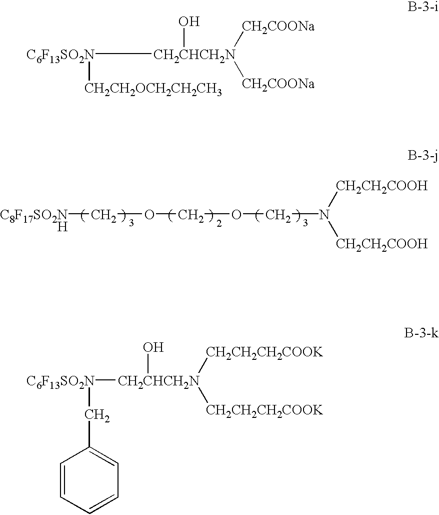

(B-4) Fluorine-Containing Trianion Type Amphoteric Surfactant Fluorine-Containing Trianion Type Amphoteric Surfactant Represented by the General Formula:

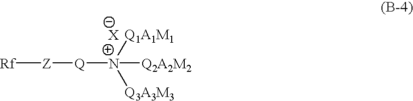

[wherein Rf represents a fluorinated aliphatic group having 3 to 20 carbon atoms, Z represents a divalent linking group, Q represents —(CH₂)ₗ— (provided that l represents an integer of 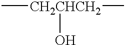 —(CH₂)ₘ—O—(CH₂)ₙ

(provided that m and n represent an integer of 2 to 6), or —(CH₂)ₚ—O—(CH₂)₂—(CH₂)_{q}— (provided that p and q represent 2 or 3),

Q₁, Q₂ and Q₃ represent a divalent aliphatic hydrocarbon group having 1 to 8 carbon atoms, a divalent aliphatic hydrocarbon group having 1 to 8 carbon atoms substituted with a hydroxyl group, or

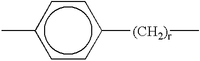

(r represents 1 or 2),

A₁ represents an anionic atomic group and includes, for example, —SO₃⁻ or —OSO₃⁻, A₂ and A₃ also represent an anionic atomic group and include, for example, —SO₃⁻, —OSO₃⁻, —COO⁻ or

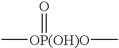

M₁, M₂ and M₃ represent a hydrogen atom, or an inorganic or organic cation, X⁻0 represents an inorganic or organic anion and is preferably OH⁻, Cl⁻, Br⁻, I⁻, ClO₄⁻, 1/2SO₄²⁻, CH₂SO₄⁻, NO₃⁻, CH₃COO⁻ or a phosphoric acid group].

Specific examples of the compound are listed below, but the present invention is not limited to the following specific examples.

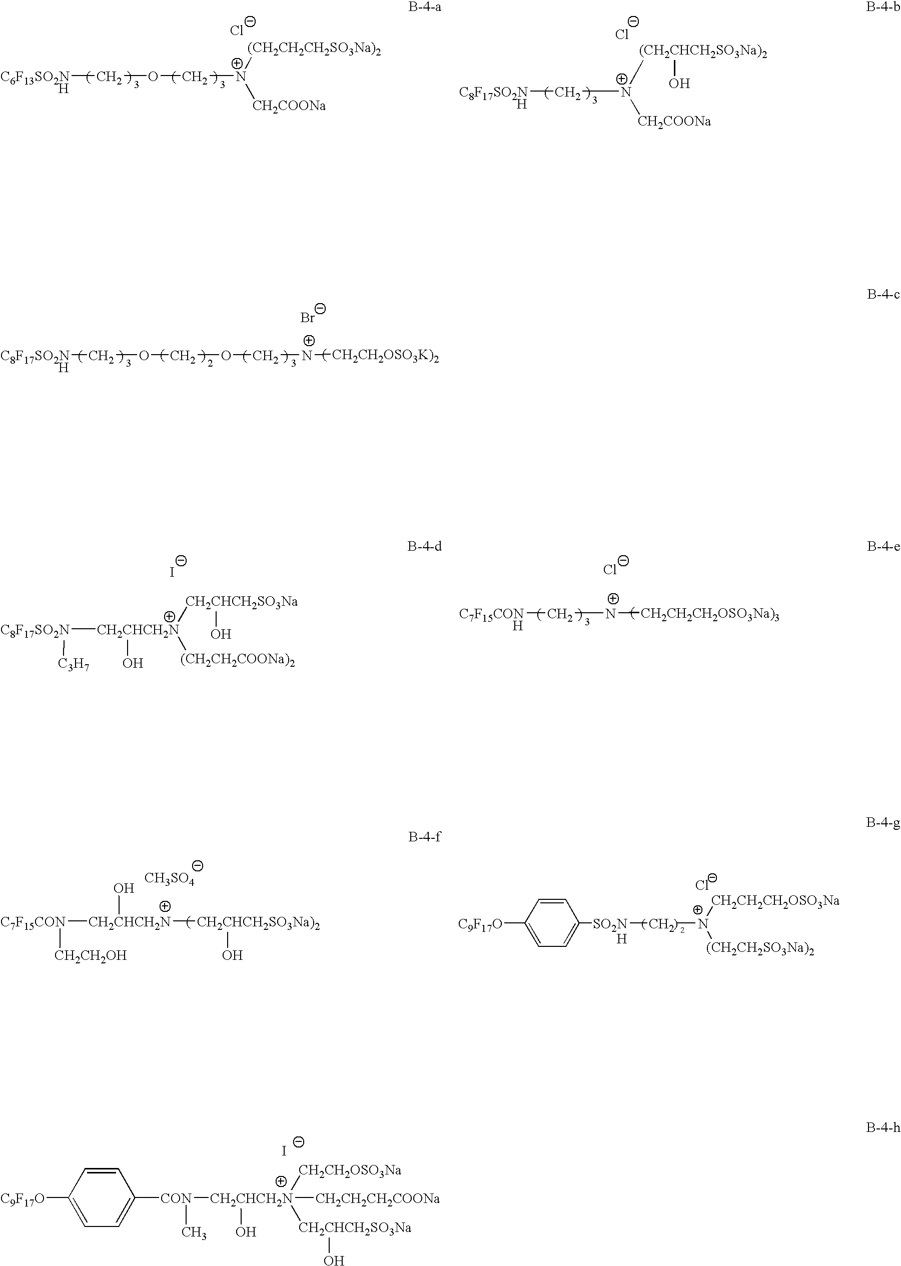

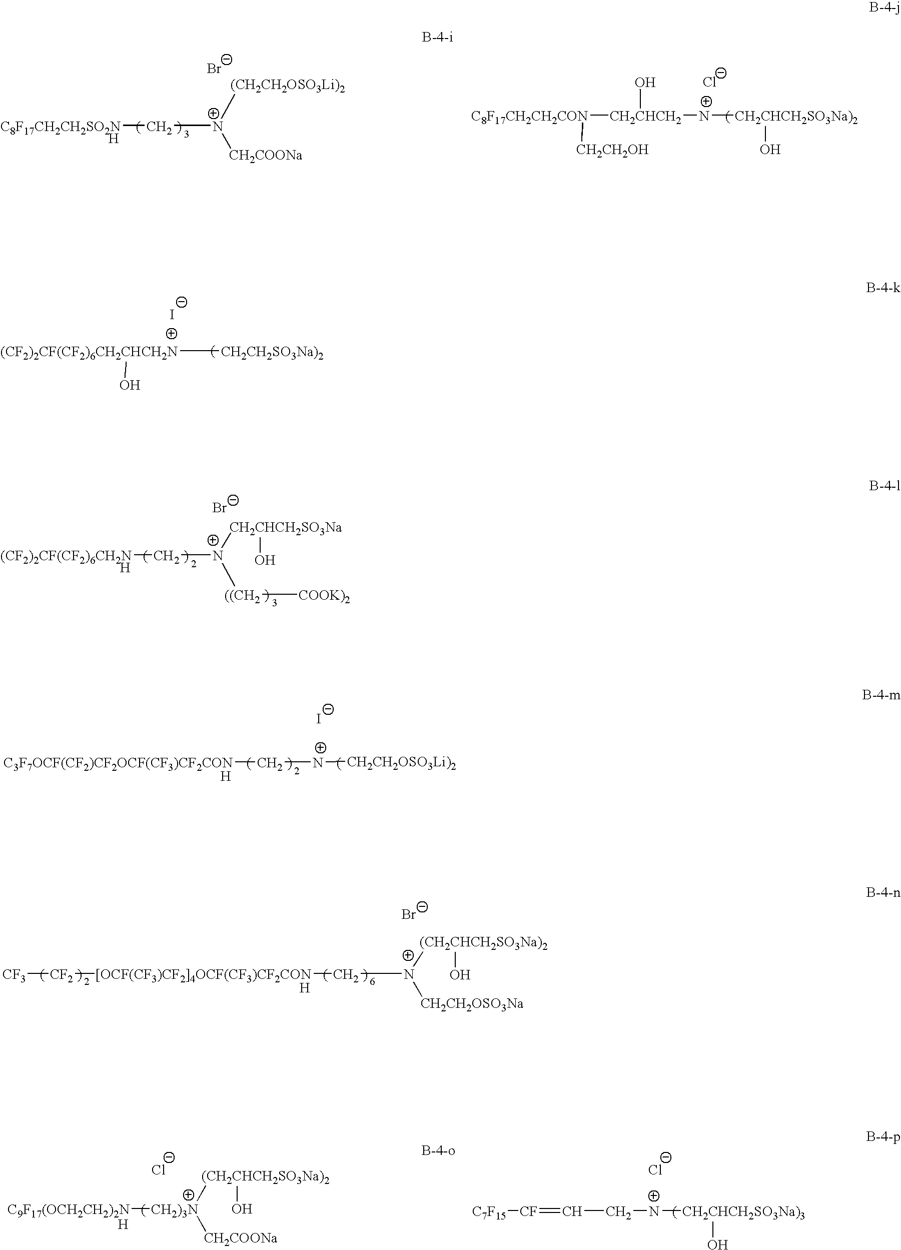

(B-5) Fluorine-Containing Tricarboxylic Acid Type Amphoteric Surfactant

Fluorine-containing tricarboxylic acid type amphoteric surfactant represented by the general formula:

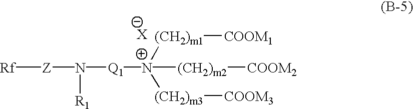

[wherein Rf represents a fluorinated aliphatic group having 3 to 20 carbon atoms, Z represents —SO₂—, —CO—, —(CH₂)ₗ—SO₂—, —(CH₂)ₗ—CO— (provided that 1 represents an integer of 1 to 6),

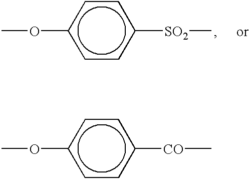

R₁ represents a hydrogen atom and includes, for example, —CH₂CH₂OH, —(CH₂)ₐ—O—(CH₂)_{b}—CH₃ (provided that a represents an integer of 2 to 10 and b represents an integer of 1 to 9), or an alkyl group having 1 to 12 carbon atoms, Q, represents —(CH₂)ₙ— (provided that n represents an integer of 2 to 6), —(CH₂)_{d}—O—(CH₂)ₑ— (provided that d and e represent an integer of 2 to 6), or

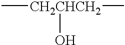

X represents an inorganic or organic anion, m₁, m₂ and m₃ represent an integer of 1 to 3 and two or all of them may be the same, M₁, M₂ and M₃ represent a hydrogen atom or an inorganic or organic cation and two or all of them may be the same].

Specific examples of the compound are listed below, but the present invention is not limited to the following specific examples.

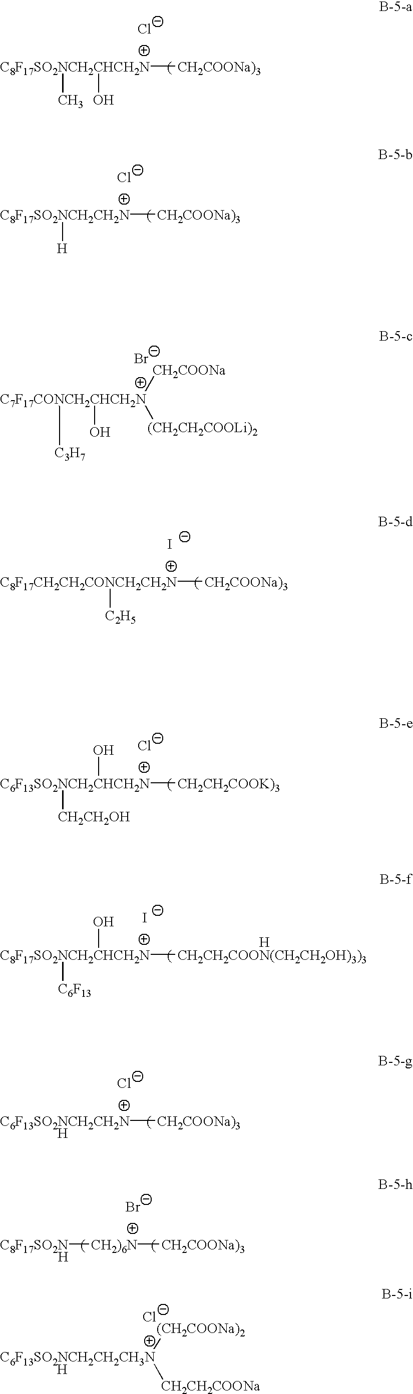

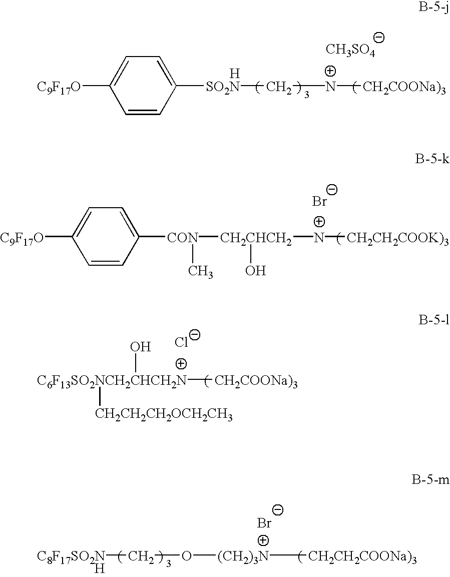

(B-6) Fluorine-Containing Sulfobetaine Type Amphoteric Surfactant

Fluorine-containing sulfobetaine type amphoteric surfactant represented by the general formula:

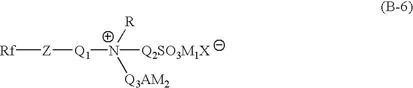

[wherein Rf represents a group having a fluorinated aliphatic group having 3 to 20 carbon atoms, Z represents a divalent linking group including a sulfoamide group or a carboamide, Q₁, Q₂ and Q₃ represent a divalent aliphatic group having 1 to 12 carbon atoms, an aliphatic hydrocarbon group substituted with a hydroxy group, an aromatic hydrocarbon group, or a combination thereof,

R represents a hydrogen atom, a hydrocarbyl group having 1 to 12 carbon atoms, or —(CH₂CH₂O)ᵢH, —(CH₂CH(CH₃)O)ᵢH (provided that I represents an integer of 1 to 20), A represents an anionic atomic group and includes, for example, —SO₂⁻, —COO⁻, —OSO₂⁻, or

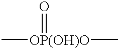

M₁ and M₂ represent a hydrogen atom, or an inorganic or organic cation, and X represents an inorganic or organic anion].

Specific examples of the compound are listed below, but the present invention is not limited to the following specific examples.

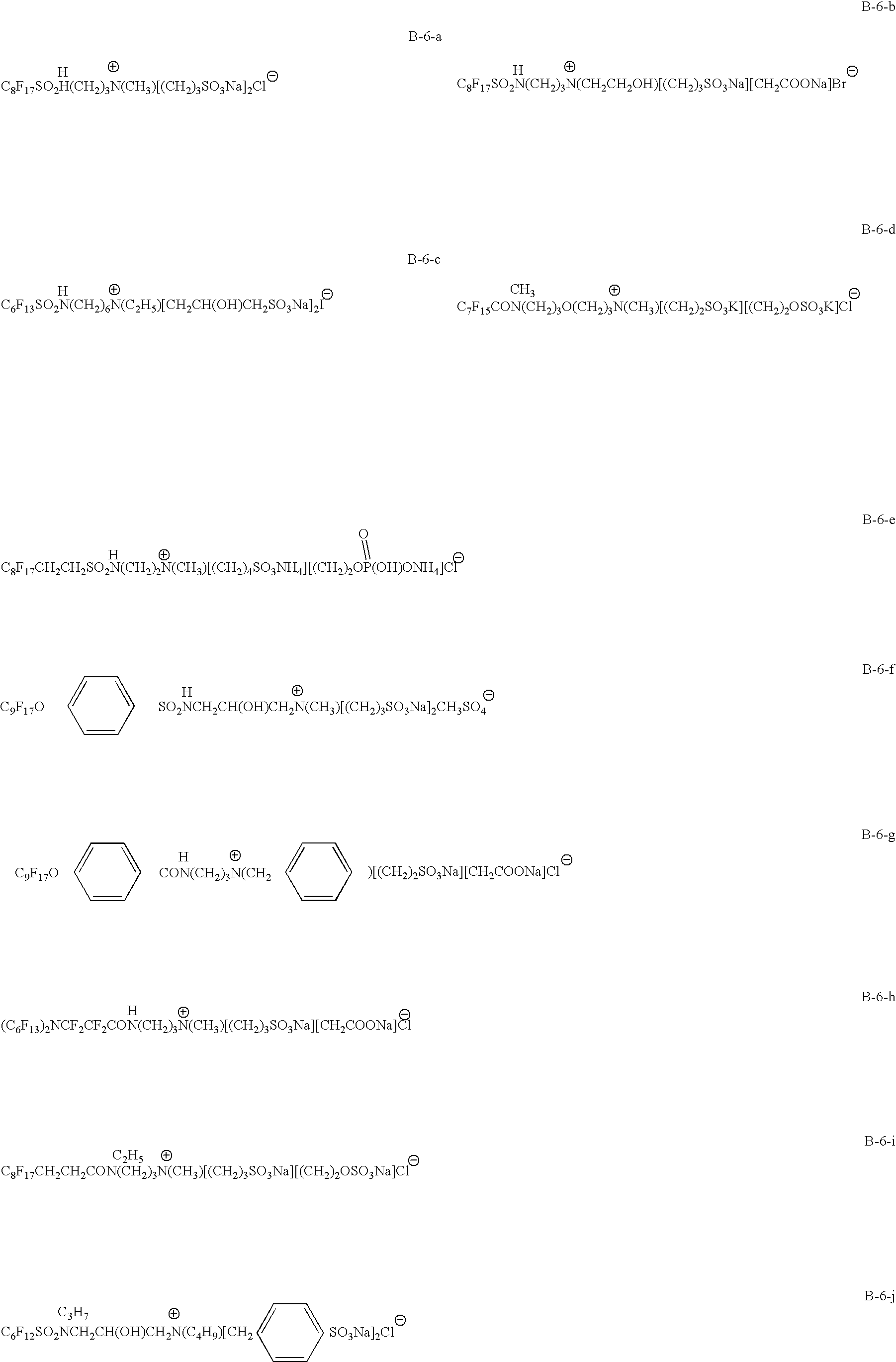

(B-7) Fluorine-Containing Aminosulfate Type Surfactant Fluorine-Containing Aminosulfate Type Surfactant Represented by the General Formula:

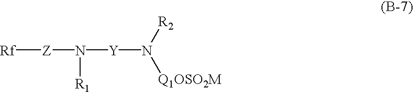

[wherein Rf represents fluorinated aliphatic group having 3 to 20 carbon atoms, Z represents —SO₂—, —CO—,

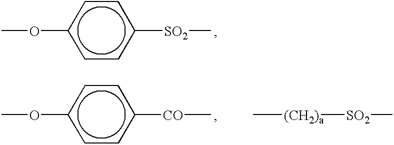

or —(CH₂)ₐ—CO— (provided that a represents an integer of 1 to 10),

R₁ represents a hydrogen atom, an alkyl group having 1 to 12 carbon atoms, —(CH₂)_{b}—OR₃, or —(CH₂CH₂O)_{d}—R₂ (provided that b represents an integer of 1 to 10, d represents an integer of 1 to 20, or R₃ represents a lower alkyl group or an alkoxyl group), Y represents —(CH₂)ₑ—, —(CH₂)ₚ—O—(CH₂)₂—O—(CH₂)_{q}—, or, —(CH₂)_{g}—O—(CH₂)ₕ (provided that e represents an integer of 2 to 12, p and q represent 2 or 3, and g and h represent an integer of 1 to 6), R₂ represents a hydrogen atom, an alkyl group, an alkenyl group or a hydroxyl-substituted alkyl group, each having 1 to 18 carbon atoms, or —(CH₂CH₂)ₘ—H (provided that m represents an integer of 2 to 20), Q₁OSO₃M, Q₁SO₂M or (CH₂)ᵢCOOM (provided that I represents an integer of 1 to 4),

Q, represents —(CH₂)ⱼ—,

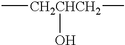

or —(CH₂CH₂°)ₖ—CH₂CH₂— (provided that j represents an integer of 2 to 12, and k represents an integer of 1 to 50), and M represents a hydrogen atom, or an inorganic or organic cation].

Specific examples of the compound are listed below, but the present invention is not limited to the following specific examples.

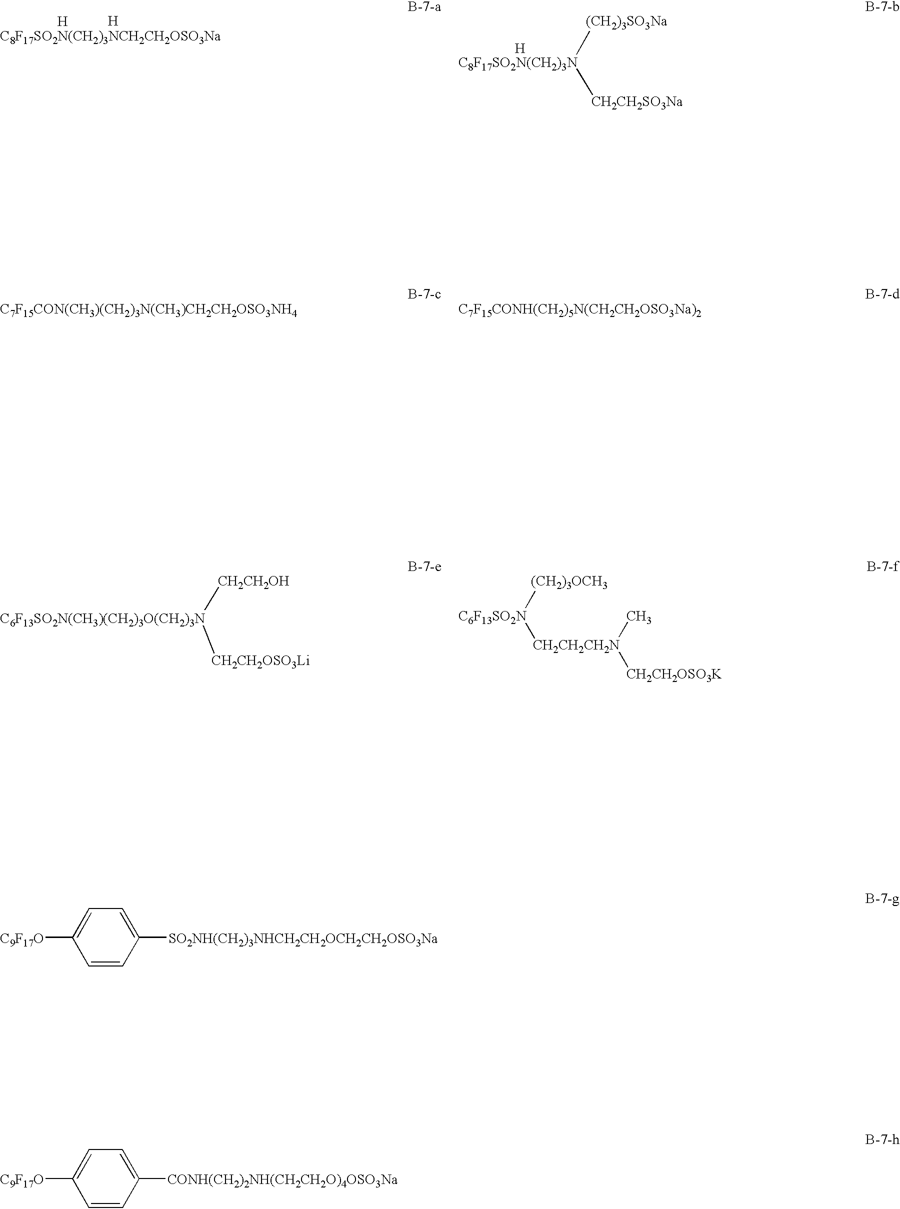

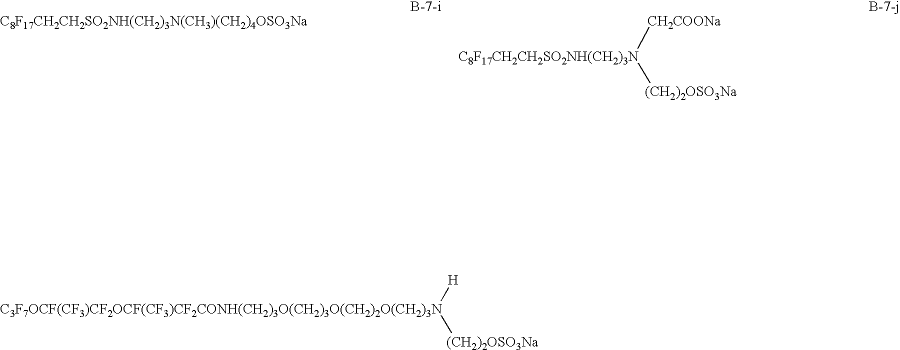

(B-8) Fluorine-Containing Sulfate Betaine Type Surfactant Fluorine-Containing Sulfate Betaine Type Surfactant Represented by the General Formula:

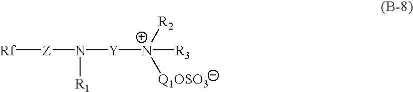

[wherein Rf represents a fluorinated aliphatic group having 3 to 20 carbon atoms, Z represents —SO₂—, —CO—,

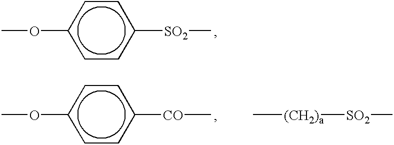

or —(CH₂)ₐ—CO— (provided that a represents an integer of 1 to 10),

R₁ represents a hydrogen atom, an alkyl group having 1 to 12 carbon atoms, —(CH₂)_{b}—OR₃, or —(CH₂CH₂O)_{d}—R₂ (provided that b represents an integer of 1 to 10, d represents an integer of 1 to 20, R₂ represents a lower alkyl group or an alkoxyl group),

Y represents —(CH₂)ₑ—, —(CH₂)ₚ—(CH₂)₂—O—(CH₂)_{q}—, or —(CH₂)_{g}—O— (CH₂)ₕ (provided that e represents an integer of 2 to 12, p and q represent 2 or 3, and g and h represent an integer of 1 to 6),

R₂ and R₃ represent an alkyl group having 1 to 18 carbon atoms, an alkenyl group, a hydroxyl-substituted alkyl group, or aromatic substituted alkyl group, —(CH₂CH₂O)ᵢ—H (provided that I represents an integer of 2 to 20) or R₂ and R₃ are combined together with adjacent nitrogen atoms to form a heterocycle, Q₁ represents —(CH₂)ⱼ—,

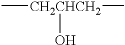

or (CH₂CH₂O)ₖ—CH₂CH₂— (provided that j represents an integer of 2 to 12, and k represents an integer of 1 to 50)].

Specific examples of the compound are listed below, but the present invention is not limited to the following specific examples.

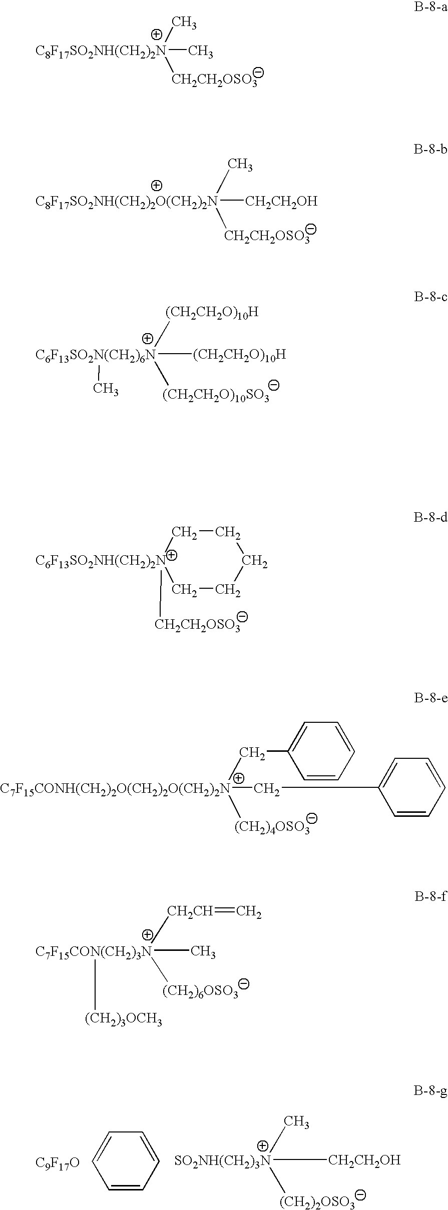

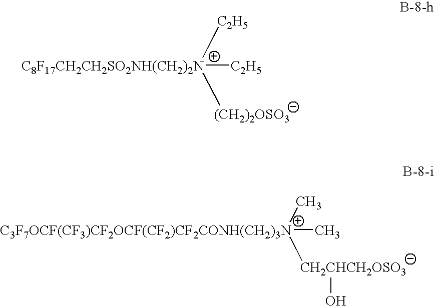

(B-9) Fluorine-Containing Sulfobetaine Type Surfactant Fluorine-Containing Sulfobetaine Type Surfactant Represented by the General Formula:

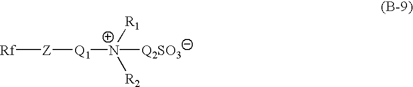

[wherein Rf represents a fluorinated aliphatic group having 3 to 20 carbon atoms which may have an oxygen atom, or a fluorinated alicyclic group, Z represents a divalent linking group,

Q₁ represents a divalent linking group of —(CH₂)₁—, —(CH₂)ₘ—O—(CH₂)ₙ— or —(CH₂)ₚ—O—(CH₂)₂—O—(CH₂)_{q}— (provided that l represents an integer of 1 to 6, m and n each represents an integer of 2 to 6, and p and q each represents 2 to 3), Q₂ represents a divalent linking group of —(CH₂)ₗ—,

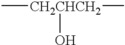

or —(CH₂CH₂O)ᵣ—CH₂CH₂— (provided that r represents an integer of 1 to 3 and 1 is as defined above), R₁ and R₂ each represents an alkyl group having 1 to 8 carbon atoms, an alkyl group or alkenyl group having 1 to 3 ether oxygens, or a benzyl group, or a monovalent group of (CH₂CH₂O), —H (provided that s represents an integer of 1 to 11)].

Specific examples of the compound are listed below, but the present invention is not limited to the following specific examples.

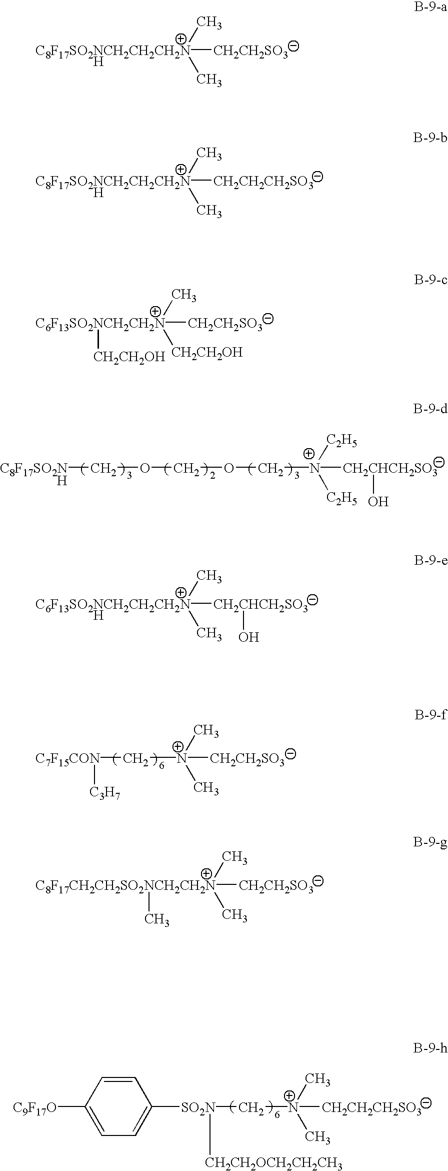

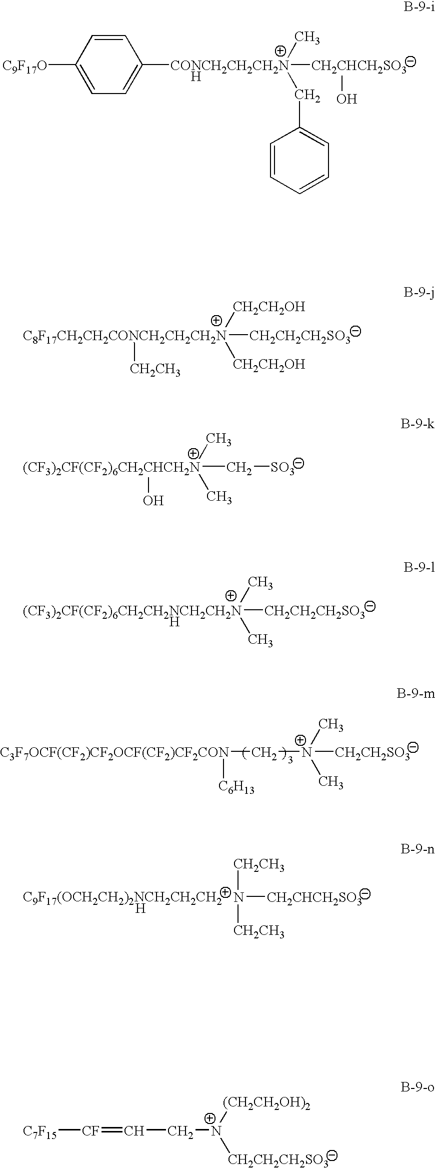

M, M₁, M₂ and M₃ in B-1 to B-9 each represents a hydrogen atom, or an inorganic or organic cation and includes, for example, Li⁺, Na⁺, K⁺, Ca⁺, Mg⁺ or [N(H)ₛ(R)ₜ]⁺. (provided that R represents an alkyl group having 1 to 4 carbon atoms or a hydroxyethyl group, s and t represent an integer of 0 to 4 and satisfy the equation: s+t=4), or preferably

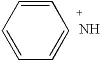

and X represents an inorganic or organic anion and is preferably OH⁻, Cl⁻, Br⁻, I⁻, ClO₄⁻, 1/2SO₄⁻, CH₂SO₄⁻, NO₃⁻, CH₃COO⁻ or a phosphoric acid group.

(B-10) Fluorine-Containing Amine Oxide Type Surfactant Fluorine-Containing Amine Oxide Type Surfactant Represented by the General Formula:

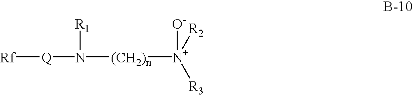

[wherein Rf represents a fluorinated aliphatic group having 8 to 18 carbon atoms, or a fluorinated alicyclic group having 10 to 20 carbon atoms containing ether oxygen or thioether, Q represents —SO₂— or —CO—, R₁ represents H, an alkyl group having 1 to 6 carbon atoms, a halogenated alkyl group having 1 to 6 carbon atoms, —OH, —SH, an alkoxy group having 1 to 6 carbon atoms, a thioalkyl group having 1 to 6 carbon atoms, NO₂, —CN or, NRR′— (R and R′ each represents H or an alkyl group having 1 to 6 carbon atoms), R₂ and R₃ each represents H, an alkyl group having 1 to 6 carbon atoms, a halogenated alkyl group having 1 to 6 carbon atoms, —OH, —SH, an alkoxy group having 1 to 6 carbon atoms, a thioalkyl group having 1 to 6 carbon atoms, —NO₂, —CN or NRR′— (R and R′ each represents H or an alkyl group having 1 to 6 carbon atoms), or an alicyclic group having a hetero atom, an alicyclic group having no hetero atom, or an alicyclic group in which a portion or all of the alicycles are substituted with an alkyl group, and n represents an integer of 2 to 6]

Specific examples of the compounds are listed below, but the present invention is not limited to the following specific examples.

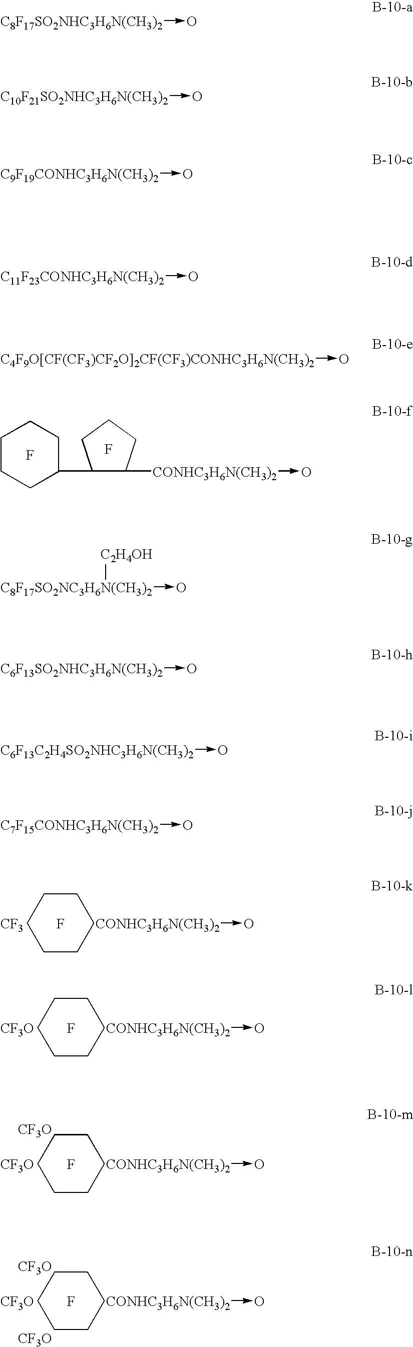

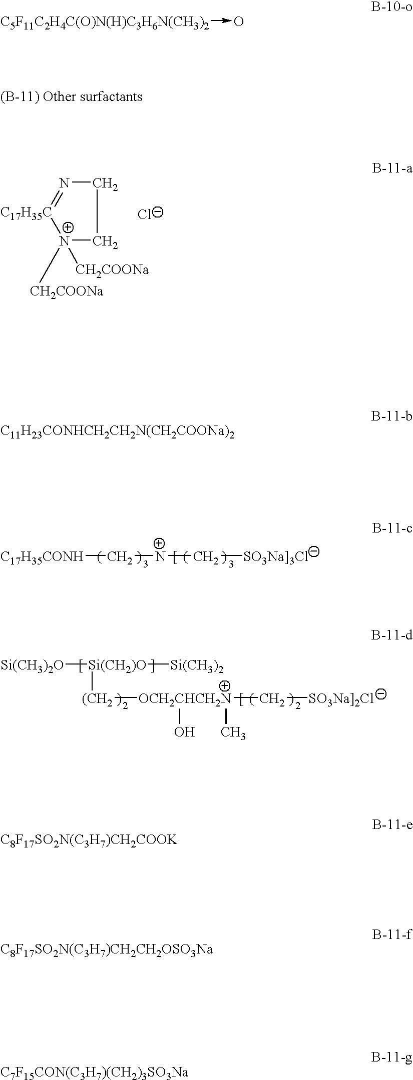

To the fire extinguishing composition of the present invention, a polybasic acid compound (C) is preferably added. The polybasic acid compound (C) in the present invention is a non-surface active compound and includes, for example, dibasic acid, tribasic acid, tetrabasic acid, pentabasic acid and hexabasic acid, each having an aromatic group, an aliphatic group or a heterocycle and having 3 to 24 carbon atoms, and alkali metal salts and ammonium salts thereof. Examples of the acid group include carboxylic acid group, sulfonic acid group and phosphoric acid group.

Furthermore, these polybasic acid compounds (C) may be used alone or used in combination. The addition of the polybasic acid compound (C) causes the electrostatic interaction with the water-soluble cationic polymeric compound (A), thus making it possible to further improve the flame resistance and fuel resistance.

The polybasic acid compound (C) is not specifically limited as long as it is a compound having an acid group in a molecule. Among these compounds, a dibasic acid compound having 4 to 18 carbon atoms is preferably used as the polybasic acid compound (C) in view of the compatibility.

Specific examples of the polybasic acid compound (C) of the present invention are listed below, but the present invention is not limited to the followings specific examples.

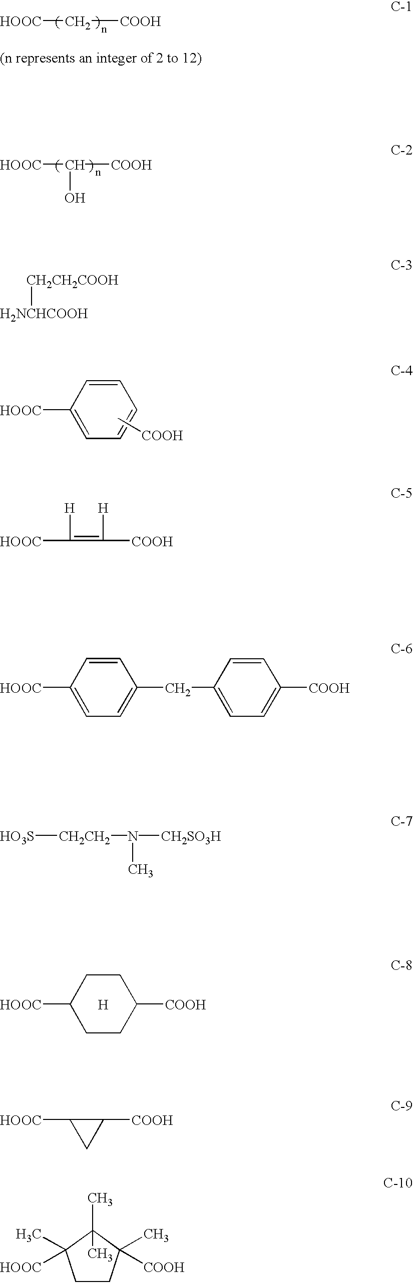

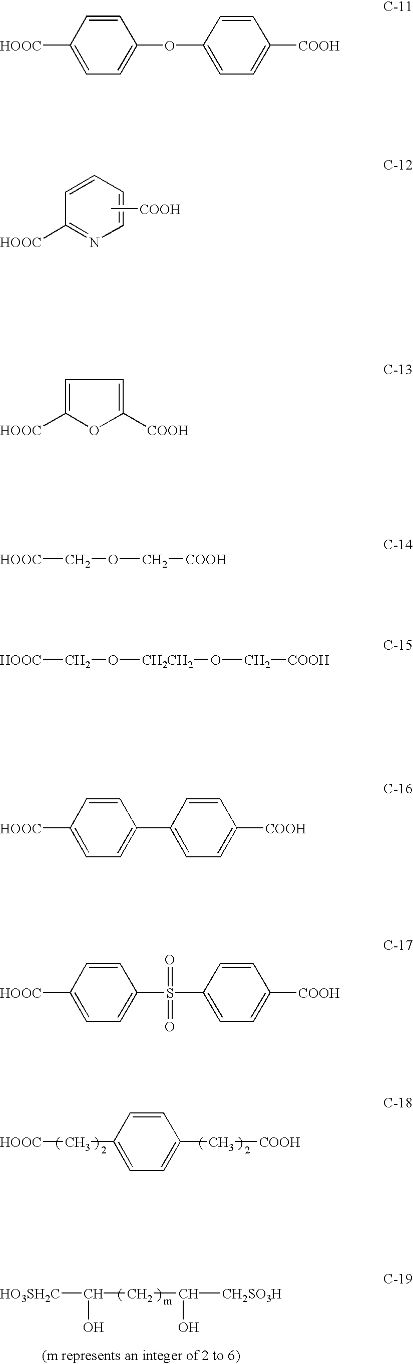

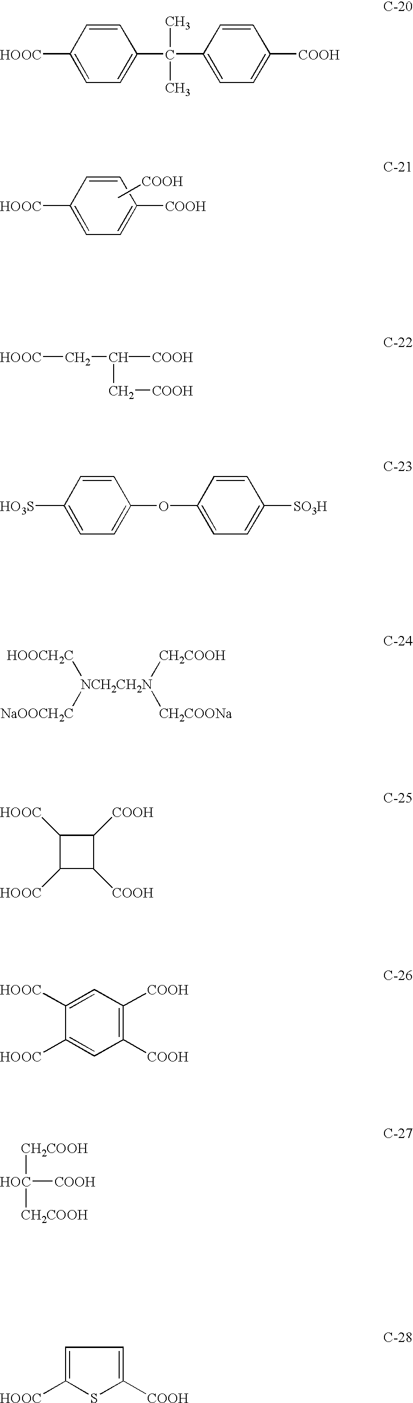

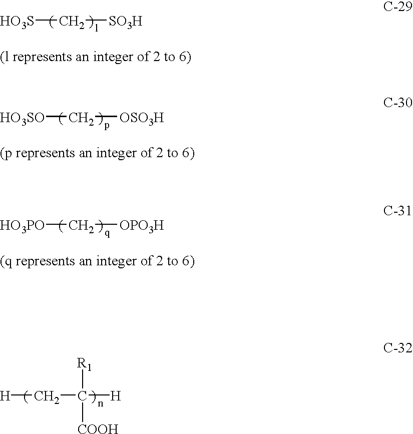

Alkali metal salts (for example, Na salt, K salt, Li salt) or ammonium salts thereof are also included.

A mixing ratio of the cationic water-soluble polymeric compound (A) to the polybasic acid compound (C) is from 5:1 to 1:3, and preferably from 4:1 to 1:1.

In the present invention, preferable ranges of mixing ratio of the anionic hydrophilic group-containing surfactant (B) to the components of the cationic polyamine-based polymeric compound (A) and the polybasic acid compound (C), [(A)+(C)], varies depending on the combination of both components, and a weight ratio of (B): [(A)+(C)] is generally within a range from 2:1 to 1:50, and preferably from 1:1 to 1:10. When the ratio of the components to the anionic hydrophilic group-containing surfactant (B) is too small, a complex formed with the anionic hydrophilic group-containing surfactant (B) becomes insoluble in water and frothing properties are drastically impaired. A mixing ratio above the above range does not considerably impair the frothing properties, flame resistance, heat resistance and fuel resistance; however, the viscosity of an undiluted solution of the fire extinguishing composition increases and it loses its commercial value.

The fire extinguishing composition of the present invention, whether in an undiluted or diluted form, has excellent dissolution stability and outstanding long-term storage stability. An undiluted solution of the fire extinguishing composition which can be diluted to a high ratio can be easily produced because of the excellent solubility and the low viscosity of the individual components. The viscosity of a 3% type undiluted solution of the fire extinguishing composition of the present invention can be adjusted to not more than 100 mm²/s at 20° C., and this solution is easy to handle in practical applications. Another characteristic of this invention is that since the amount of the cationic polyamine-based polymeric substance (A) can be small, it is easy to reduce the freezing point of the undiluted solution of the fire extinguishing composition to −5° C.

With respect to the fire extinguishing composition of the present invention, in order to further improve the fire extinguishing performance against non-polar solvents such as petroleums, a cationic hydrophilic group-containing surfactant (D) can be appropriately mixed for the purpose of exerting a function of effectively reducing the surface tension of the fire extinguishing composition and the interfacial tension with oil.

The cationic hydrophilic group-containing surfactant (D) is not specifically limited as long as it is a surfactant having a cationic hydrophilic group. Examples of the cationic hydrophilicgroup include pyridinium salt, quaternary ammonium salt, imidazolinium salt and benzalkonium salt. Among these groups, a group of a pyridinium salt and a group of a quaternary ammonium salt are preferred in view of compatibility and a quaternary ammonium salt is more preferred. A counter ion in a cationic group has an organic or inorganic anion. Examples of the hydrophobic group of the surfactant include organic or inorganic anion having 6 or more carbon atoms, dihydrocarbylsiloxane chain, and fluorinated aliphatic group having 3 to 20 carbon atoms, and preferably 6 to 16 carbon atoms. A surfactant having a fluorinated aliphatic group is preferred in view of the effect of improving the fire extinguishing performance.

The cationic hydrophilic group-containing surfactant (D), which is particularly useful in the present invention, is represented by the following general formula (D-1):

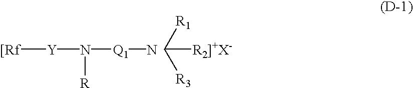

[wherein Rf represents a fluorinated aliphatic group having 3 to 20 carbon atoms, which may contain an oxygen atom, Y represents —(CH₂CH₂)ᵢ—, —CH₂CH₂ SCH₂COO—, —(CH₂CH₂)ᵢ—SO₂—, —(CH₂CH₂)ᵢ—CO—,

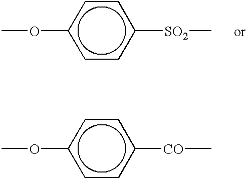

(provided that i represents an integer of 1 to 6),

R represents a hydrogen atom or an aliphatic hydrocarbon group having 1 to 6 carbon atoms, Q1 represents an organic divalent linking group and includes, for example, an aliphatic hydrocarbon group, an aliphatic hydrocarbon group substituted with a hydroxy group, an aromatic hydrocarbon group or a substituted aromatic hydrocarbon group, and is preferably —(CH₂)—ⱼ (j represents an integer of 1 to 6), R₁ to R₃ may be the same or different and represents a hydrogen atom or an aliphatic hydrocarbon group having 1 to 6 carbon atoms, and X-represents an organic or inorganic anion].

To the fire extinguishing composition of the present invention, various additives can be added. Examples of the additives include additional foam stabilizers, freezing point depressants, rust preventives and pH adjustors.

The additional foam stabilizer is mainly added to control the foaming ratio or drainage and examples thereof include nonionic surfactants such as glycerin aliphatic ester, propylene glycol fatty acid ester, sorbitan fatty acid ester, polyoxyethylene sorbitol fatty acid ester, polyoxyethylene alkyl ether, polyoxyethylene polyoxypropylene ether, polyethylene glycol fatty acid ester, alkyl alkanolamide and alkyl polyglucoside; amphoteric surfactants such as alkyl dimethylaminoacetic acid betaine, alkyl dimethylamine oxide, alkyl carboxymethylhydroxyethylimidazolium betaine, alkyl amidepropyl betaine and alkyl hydroxysulfobetaine; and polyethylene glycol, polyvinyl alcohol, polyvinyl pyrrolidone, carboxymethylcellulose, gum arabic, sodium alginate, polypropylene glycol and polyvinyl resin.

Examples of the freezing point depressant include ethylene glycol, propylene glycol, cellosolves (for example, ethylcellosolve, butylcellosolve); carbitols (for example, ethylcarbitol, butylcarbitol, hexylcarbitol, octylcarbitol), lower alcohols (for example, isopropyl alcohol, butanol, octanol) and urea.

The method of application of the fire extinguishing composition of the present invention will now be described.

The fire extinguishing composition of the present invention can be applied to the site of fire by a known method, specifically by blowing or mixing air, carbon dioxide gas, nitrogen, a low-boiling fluorocarbon such as difluorodichloromethane, or another suitable incombustible gas into or with it.

Since the viscosity of an undiluted solution of the fire extinguishing composition of the present invention is relatively low, when the undiluted solution of the fire extinguishing composition is stored in a storage tank, it is diluted to a suitable ratio by conventional methods (for example, by causing it to be drawn into a water stream being sent toward a fire extinguishing device or a foam nozzle), and mixed with an incombustible gas such as air to foam it, and the resulting foams are sprayed over or sent to the burning surface from above or below the burning surface. After previously diluting an undiluted solution of the fire extinguishing composition in a ratio suitable for use, a fire extinguishing device, fire extinguisher for a parking lot, fire extinguisher for fixation to a flammable article, or package type fire extinguisher is filled with the resulting dilute solution.

In a method for discharging the fire extinguishing composition of the present invention, any nozzle can be used as long as it is a conventionally known spray nozzle used for the purposes of fire extinguishing compositions known in the industry, and thus desired performances can be exerted.

Examples of the nozzle include a foam chamber used generally in oil storage tanks, a nozzle in conformity with the ISO Standard, a nozzle in conformity with the UL Standard, a nozzle in conformity with the MIL Standard, a hand nozzle attached to a fire engine for chemical fires, an air foam hand nozzle, a nozzle for SSI, an HK nozzle stipulated by Japanese Ship Article Society, a foam head used in fire extinguishing equipment for parking lots, and a spray head.

As described above, the fire extinguishing composition of the present invention can be used in various spray methods. The fire extinguishing composition of the present invention can be ore widely used for various purposes compared with conventional fire extinguishing compositions. As a matter of course, the fire extinguishing composition of the present invention can be used in a fire engine for chemical fires and in undiluted solution conveyance vehicles of public fire extinguishing agencies and also, it can be preferably used in petroleum sites and factories provided with crude oil tanks and flammable substance facilities, airport facilities, port facilities and marine vessels loaded with flammable substances, gas stations, underground parking lots, buildings, tunnels and bridges. Also it can be preferably used against conventional fires other than fires of liquid flammable substances, for example, wood fires such as of houses, rubber fires such as of tires, and plastic fires.

Since the fire extinguishing composition of the present invention is also superior in fuel resistance, flame resistance, heat resistance and foaming properties, it is suited for use in smothering or cooling fire extinguishing of fires of tempura oil or salad oil by directly spraying the undiluted or aqueous dilute solution over the burning oil surface. The fire extinguishing composition of the present invention can be used as a portable domestic initial fire-extinguishing device after filling a spray can with the dilute solution of the fire extinguishing composition because it is superior in dilute dissolution stability.

Foams of the fire extinguishing composition of the present invention can be stably present on aqueous solutions containing water as a base substance, gel-sol-like substances, sludges, wastes, various organic solvents and organic compounds, thus making it possible to suppress vaporization of the substance volatilized from these substances and to prevent ignition of flammable substances and emissions of odor. The fire extinguishing composition of the present invention may be used in combination with powdered fire extinguishers, protein foam extinguishers or foam fire extinguishers containing sodium bicarbonate, potash bicarbonate, magnesium bicarbonate, ammonium sulfate, ammonium phosphate, calcium carbonate or the like as components.

### EXAMPLES

The following examples illustrate the present invention in greater detail. All percentages in the following Examples and Comparative Examples are by weight.

(Measurement of Viscosity)

Among cationic polyamine-based polymeric compounds, the viscosity of polyethyleneimines (A-I) having different viscosities was measured. The results are shown in Table 1. The viscosity was measured by using Bismetron viscometer manufactured by SHIBAURA SYSTEMS CO., LTD. using a No. 3 rotor at 6 rpm.

TABLE 1

| Cationic polymeric substance (A) | Viscosity (mPa · s) |
|---|---|
| A-I-1 | 16470 |
| A-I-2 | 28680 |
| A-I-3 | 8300 |
| A-I-4 | 32750 |

### Examples 1 to 40

<Formulation>

| | |
|---|---|
| Cationic polyamine-based polymeric compound (A) | 5% |
| Anionic hydrophilic group-containing surfactant (B) | 4% |
| Polybasic acid (C) | 3% |
| Butylcarbitol | 15% |
| Ethylene glycol | 15% |
| Water | 58% |

A cationic polyamine-based polymeric compound (A), an anionic hydrophilic group-containing surfactant (B) and a polybasic acid (C) were mixed in accordance with the above formulation with stirring and the pH of the mixture was adjusted to 7.5 by adding a trace amount of 5M hydrochloric acid. The kinds of the cationic polyamine-based polymeric compound (A), the surfactant (B) and the polybasic acid (C) as well as the appearance, the freezing point and the kinematic viscosity of the resulting fire extinguishing composition (3% type undiluted solution) and the amount of the precipitate of a 3% tap water dilute solution measured based on the technical standard described in Ordinance No. 26 of the Ministry of Home Affairs of Japan, are shown in Table 2 and Table 3.

The method of measuring the kinematic viscosity shown in the tables is different from that of the above viscosity. The kinematic viscosity of the foam-type fire extinguishing composition can be measured by a method stipulated in Japanese Government Inspection Regulations based on Ministerial Ordinance Stipulating Technical Standards of Foam-type Fire Extinguishing Compositions, established on Dec. 9, 1975 (Ordinance No. 26 of the Ministry of Home Affairs of Japan). More specifically, as described in the Method of Test for Kinematic Viscosity and Viscosity of Petrochemical Products in accordance with JIS K 2283, a Cannon-Fenske or an Ubbelohde viscometer is vertically placed in a thermostatic bath maintained at 20° C. and each of the samples was allowed to stand for 10 minutes until it reached a test temperature, and then a flow-down time between marked lines was measured when the sample was allowed to naturally flow out between the marked lines, and thus the viscosity can be calculated by multiplying the resulting flow-down time by a constant of individual viscometers using the following calculation equation:

v=c×t

where

v denotes a kinematic viscosity (mm²/s),

c denotes a viscometer constant(mm²/s²), and

t denotes a flow-down time (s).

TABLE 2

| | Cationic | | | | | Kinematic | Test for |
|---|---|---|---|---|---|---|---|
| | polymeric | | | | | viscosity | amount of |
| | substance | Surfactant | Polybasic | | Freezing | at | precipitate* |
| | (A) | (B) | acid (C) | Appearance | point (° C.) | −10° C. (cst) | (vol %) |
| Example 1 | A-I-1 | B-1-a | C-1 (n = 4) | Completely | −19 | 126 | Trace |
| | | | | clear | | | |
| Example 2 | A-I-1 | B-1-m | C-1 (n = 4) | Completely | −18 | 133 | Trace |
| | | | | clear | | | |
| Example 3 | A-I-1 | B-1-t | C-1 (n = 6) | Completely | −17 | 132 | Trace |
| | | | | clear | | | |
| Example 4 | A-I-2 | B-1-e | C-2 | Completely | −17 | 100 | Trace |
| | | | | clear | | | |
| Example 5 | A-I-2 | B-1-h | C-4 | Completely | −17 | 144 | Trace |
| | | | | clear | | | |
| Example 6 | A-I-2 | B-1-n | C-3 | Completely | −18 | 122 | Trace |
| | | | | clear | | | |
| Example 7 | A-I-2 | B-1-m | C-13 | Completely | −16 | 119 | Trace |
| | | | | clear | | | |
| Example 8 | A-I-1 | B-1-u | C-16 | Completely | −19 | 136 | Trace |
| | | | | clear | | | |
| Example 9 | A-I-1 | B-2-a | C-23 | Completely | −18 | 140 | Trace |
| | | | | clear | | | |
| Example 10 | A-I-1 | B-2-c | C-1 (n = 4) | Completely | −18 | 97 | Trace |
| | | | | clear | | | |
| Example 11 | A-I-1 | B-2-j | C-24 | Completely | −17 | 111 | Trace |
| | | | | clear | | | |
| Example 12 | A-I-1 | B-2-o | C-31 (q = 2) | Completely | −20 | 125 | Trace |
| | | | | clear | | | |
| Example 13 | A-I-2 | B-2-g | C-28 | Completely | −16 | 133 | Trace |
| | | | | clear | | | |
| Example 14 | A-I-2 | B-2-c | C-1 (n = 6) | Completely | −18 | 124 | Trace |
| | | | | clear | | | |
| Example 15 | A-I-2 | B-2-c | C-16 | Completely | −17 | 129 | Trace |
| | | | | clear | | | |
| Example 16 | A-I-2 | B-2-k | C-10 | Completely | −17 | 130 | Trace |
| | | | | clear | | | |
| Example 17 | A-I-1 | B-3-i | C-17 | Completely | −16 | 117 | Trace |
| | | | | clear | | | |
| Example 18 | A-I-2 | B-3-d | C-7 | Completely | −16 | 140 | Trace |
| | | | | clear | | | |
| Example 19 | A-I-1 | B-4-b | C-1 (n = 4) | Completely | −19 | 118 | Trace |
| | | | | clear | | | |
| Example 20 | A-I-1 | B-4-e | C-14 | Completely | −18 | 123 | Trace |
| | | | | clear | | | |
| Example 21 | A-I-1 | B-4-g | C-14 | Completely | −16 | 117 | Trace |
| | | | | clear | | | |
| Example 22 | A-I-1 | B-5-c | C-1 (n = 2) | Completely | −17 | 134 | Trace |
| | | | | clear | | | |
| Example 23 | A-I-1 | B-5-i | C-10 | Completely | −17 | 128 | Trace |
| | | | | clear | | | |
| Example 24 | A-I-1 | B-6-d | C-1 (n = 4) | Completely | −18 | 139 | Trace |
| | | | | clear | | | |
| Example 25 | A-I-1 | B-6-c | C-11 | Completely | −18 | 131 | Trace |
| | | | | clear | | | |
| Example 26 | A-I-1 | B-6-b | C-28 | Completely | −19 | 113 | Trace |
| | | | | clear | | | |
| Example 27 | A-I-2 | B-6-a | C-16 | Completely | −16 | 122 | Trace |
| | | | | clear | | | |
| Example 28 | A-I-2 | B-6-f | C-22 | Completely | −20 | 137 | Trace |
| | | | | clear | | | |
| Example 29 | A-I-2 | B-6-e | C-3 | Completely | −18 | 140 | Trace |
| | | | | clear | | | |
| Example 30 | A-I-2 | B-6-a | C-26 | Completely | −17 | 117 | Trace |
| | | | | clear | | | |
| Example 31 | A-I-2 | B-7-g | C-16 | Completely | −18 | 130 | Trace |
| | | | | clear | | | |
| Example 32 | A-I-1 | B-7-k | C-18 | Completely | −16 | 109 | Trace |
| | | | | clear | | | |
| Example 33 | A-I-1 | B-8-d | C-23 | Completely | −17 | 122 | Trace |
| | | | | clear | | | |

*Conducted in accordance with the method for measuring the amount of precipitate described in Ordinance No. 26 of the Ministry of Home Affairs of Japan

TABLE 3

| | Cationic | | | | | Kinematic | Test for |
|---|---|---|---|---|---|---|---|
| | polymeric | | | | | viscosity | amount of |
| | substance | Surfactant | Polybasic | | Freezing | at | precipitate* |
| | (A) | (B) | acid (C) | Appearance | point (° C.) | −10° C. (cst) | (vol %) |
| Example 34 | A-I-1 | B-8-e | C-24 (n = 4) | Completely | −18 | 150 | Trace |
| | | | | clear | | | |
| Example 35 | A-I-1 | B-9-a | C-28 | Completely | −18 | 149 | Trace |
| | | | | clear | | | |
| Example 36 | A-I-2 | B-9-e | C-31 | Completely | −17 | 128 | Trace |
| | | | | clear | | | |
| Example 37 | A-I-1 | B-9-1 | C-1 (n = 8) | Completely | −17 | 134 | Trace |
| | | | | clear | | | |
| Example 38 | A-I-1 | B-9-a | C-1 (n = 4) | Completely | −16 | 133 | Trace |
| | | | | clear | | | |
| Example 39 | A-I-1 | B-10-a | C-1 (n = 4) | Completely | −18 | 162 | Trace |
| | | | | clear | | | |
| Example 40 | A-I-1 | B-10-b | C-10 | Completely | −19 | 169 | Trace |
| | | | | clear | | | |

*Conducted in accordance with the method for measuring the amount of precipitate described in Ordinance No. 26 of the Ministry of Home Affairs of Japan

Furthermore, for non-polar solvents (solvents which dissolve in 100 g of water at a temperature of 20° C. in an amount of less than 1 g), a fire extinguishing test was carried out based on the method described in Ordinance No. 26 of the Ministry of Home Affairs of Japan. The results are shown in Table 4, Table 5 and Table 6. A fire model [fuel: 200 L of n-heptane, combustion area: 4 m2 (B-20 scale)] was used and a pre-burning time was 1 minute. Each of the undiluted solutions of fire extinguishing compositions shown in the examples was diluted 33.3 times with water and 100 liters of the resulting dilute solution was filled in a pressure container. This was foamed under a nitrogen pressure of 7 kg/cm² by passing it through a standard foaming nozzle for testing aqueous film forming foam-type fire extinguishing composition (products having passed government inspection). The spray rate was adjusted to 10 liters/min and the total spray time was adjusted to 5 minutes. The temperature of any dilute solution was adjusted to 20° C.±2° C. The time required to cover 90% of the combustion area (90% control time) which functions as an index of superiority or inferiority of the spreading rate of the foams and the complete fire extinguishing time, which represents the fire extinguishing rate most plainly, were measured, and then the vapor sealing test which functions as an index of the re-ignition preventive performance and the burnback test which functions as an index of the flame resistance were evaluated.

TABLE 4

| | | Dilution | | 90% control | Fire | | |
|---|---|---|---|---|---|---|---|
| | Dilution | ratio | Burning | time | extinguishing | Vapor | Burnback |
| | water | (%) | solvent | (seconds) | time | sealing test | test (cm²) |
| Example 1 | Fresh water | 3 | n-heptane | 30″ | 1′11″ | not ignited | 5 |
| | Sea water | 3 | n-heptane | 31″ | 1′26″ | not ignited | 20 |
| Example 2 | Fresh water | 3 | n-heptane | 30″ | 1′18″ | not ignited | 10 |
| | Sea water | 3 | n-heptane | 36″ | 1′24″ | not ignited | 10 |
| Example 3 | Fresh water | 3 | n-heptane | 33″ | 1′08″ | not ignited | 6 |
| | Sea water | 3 | n-heptane | 34″ | 1′20″ | not ignited | 15 |
| Example 4 | Fresh water | 3 | n-heptane | 31″ | 1′13″ | not ignited | 20 |
| | Sea water | 3 | n-heptane | 36″ | 1′19″ | not ignited | 30 |
| Example 5 | Fresh water | 3 | n-heptane | 36″ | 1′20″ | not ignited | 0 |
| | Sea water | 3 | n-heptane | 33″ | 1′25″ | not ignited | 0 |
| Example 6 | Fresh water | 3 | n-heptane | 33″ | 1′13″ | not ignited | 8 |
| | Sea water | 3 | n-heptane | 37″ | 1′18″ | not ignited | 11 |
| Example 7 | Fresh water | 3 | n-heptane | 30″ | 1′09″ | not ignited | 0 |
| | Sea water | 3 | n-heptane | 32″ | 1′16″ | not ignited | 20 |
| Example 8 | Fresh water | 3 | n-heptane | 31″ | 1′12″ | not ignited | 0 |
| | Sea water | 3 | n-heptane | 31″ | 1′18″ | not ignited | 0 |
| Example 9 | Fresh water | 3 | n-heptane | 29″ | 1′07″ | not ignited | 2 |
| | Sea water | 3 | n-heptane | 28″ | 1′12″ | not ignited | 3 |
| Example 10 | Fresh water | 3 | n-heptane | 36″ | 1′20″ | not ignited | 30 |
| | Sea water | 3 | n-heptane | 34″ | 1′22″ | not ignited | 35 |
| Example 11 | Fresh water | 3 | n-heptane | 35″ | 1′19″ | not ignited | 0 |
| | Sea water | 3 | n-heptane | 36″ | 1′27″ | not ignited | 0 |
| Example 12 | Fresh water | 3 | n-heptane | 30″ | 1′24″ | not ignited | 10 |
| | Sea water | 3 | n-heptane | 33″ | 1′28″ | not ignited | 20 |
| Example 13 | Fresh water | 3 | n-heptane | 29 | 1′13″ | not ignited | 0 |
| | Sea water | 3 | n-heptane | 28 | 1′19″ | not ignited | 0 |
| Example 14 | Fresh water | 3 | n-heptane | 37 | 1′26″ | not ignited | 10 |
| | Sea water | 3 | n-heptane | 35 | 1′33″ | not ignited | 0 |
| Example 15 | Fresh water | 3 | n-heptane | 35 | 1′17″ | not ignited | 20 |
| | Sea water | 3 | n-heptane | 34 | 1′21″ | not ignited | 30 |
| Example 16 | Fresh water | 3 | n-heptane | 34 | 1′22″ | not ignited | 0 |
| | Sea water | 3 | n-heptane | 35 | 1′18″ | not ignited | 0 |
| Example 17 | Fresh water | 3 | n-heptane | 38 | 1′30″ | not ignited | 50 |
| | Sea water | 3 | n-heptane | 39 | 1′36″ | not ignited | 10 |

TABLE 5

| | | Dilution | | 90% control | Fire | | |
|---|---|---|---|---|---|---|---|
| | Dilution | ratio | Burning | time | extinguishing | Vapor | Burnback |
| | water | (%) | solvent | (seconds) | time | sealing test | test (cm²) |
| Example 18 | Fresh water | 3 | n-heptane | 37″ | 1′27″ | not ignited | 0 |
| | Sea water | 3 | n-heptane | 38″ | 1′31″ | not ignited | 0 |
| Example 19 | Fresh water | 3 | n-heptane | 29″ | 1′11″ | not ignited | 18 |
| | Sea water | 3 | n-heptane | 29″ | 1′14″ | not ignited | 31 |
| Example 20 | Fresh water | 3 | n-heptane | 31″ | 1′15″ | not ignited | 22 |
| | Sea water | 3 | n-heptane | 33″ | 1′17″ | not ignited | 0 |
| Example 21 | Fresh water | 3 | n-heptane | 29″ | 1′10″ | not ignited | 0 |
| | Sea water | 3 | n-heptane | 28″ | 1′15″ | not ignited | 0 |
| Example 22 | Fresh water | 3 | n-heptane | 35″ | 1′28″ | not ignited | 45 |
| | Sea water | 3 | n-heptane | 36″ | 1′26″ | not ignited | 30 |
| Example 23 | Fresh water | 3 | n-heptane | 33″ | 1′30″ | not ignited | 0 |
| | Sea water | 3 | n-heptane | 34″ | 1′33″ | not ignited | 10 |
| Example 24 | Fresh water | 3 | n-heptane | 29″ | 1′15″ | not ignited | 0 |
| | Sea water | 3 | n-heptane | 28″ | 1′14″ | not ignited | 0 |
| Example 25 | Fresh water | 3 | n-heptane | 32″ | 1′16″ | not ignited | 20 |
| | Sea water | 3 | n-heptane | 31″ | 1′16″ | not ignited | 30 |
| Example 26 | Fresh water | 3 | n-heptane | 35″ | 1′22″ | not ignited | 26 |
| | Sea water | 3 | n-heptane | 36″ | 1′30″ | not ignited | 12 |
| Example 27 | Fresh water | 3 | n-heptane | 31″ | 1′11″ | not ignited | 0 |
| | Sea water | 3 | n-heptane | 29″ | 1′16″ | not ignited | 0 |
| Example 28 | Fresh water | 3 | n-heptane | 29″ | 1′14″ | not ignited | 30 |
| | Sea water | 3 | n-heptane | 28″ | 1′16″ | not ignited | 35 |
| Example 29 | Fresh water | 3 | n-heptane | 31″ | 1′22″ | not ignited | 10 |
| | Sea water | 3 | n-heptane | 33″ | 1′25″ | not ignited | 0 |
| Example 30 | Fresh water | 3 | n-heptane | 31″ | 1′21″ | not ignited | 38 |
| | Sea water | 3 | n-heptane | 30″ | 1′27″ | not ignited | 25 |
| Example 31 | Fresh water | 3 | n-heptane | 36″ | 1′35″ | not ignited | 50 |
| | Sea water | 3 | n-heptane | 38″ | 1′38″ | not ignited | 60 |
| Example 32 | Fresh water | 3 | n-heptane | 37″ | 1′37″ | not ignited | 5 |
| | Sea water | 3 | n-heptane | 35″ | 1′33″ | not ignited | 0 |
| Example 33 | Fresh water | 3 | n-heptane | 36″ | 1′39″ | not ignited | 0 |
| | Sea water | 3 | n-heptane | 36″ | 1′31″ | not ignited | 0 |
| Example 34 | Fresh water | 3 | n-heptane | 31″ | 1′33″ | not ignited | 14 |
| | Sea water | 3 | n-heptane | 31″ | 1′32″ | not ignited | 15 |

TABLE 6

| | | Dilution | | 90% control | Fire | | |
|---|---|---|---|---|---|---|---|
| | Dilution | ratio | Burning | time | extinguishing | Vapor | Burnback |
| | water | (%) | solvent | (seconds) | time | sealing test | test (cm²) |
| Example 35 | Fresh water | 3 | n-heptane | 37″ | 1′27″ | not ignited | 0 |
| | Sea water | 3 | n-heptane | 33″ | 1′23″ | not ignited | 30 |
| Example 36 | Fresh water | 3 | n-heptane | 31″ | 1′20″ | not ignited | 20 |
| | Sea water | 3 | n-heptane | 33″ | 1′19″ | not ignited | 26 |
| Example 37 | Fresh water | 3 | n-heptane | 29″ | 1′23″ | not ignited | 50 |
| | Sea water | 3 | n-heptane | 28″ | 1′25″ | not ignited | 35 |
| Example 38 | Fresh water | 3 | n-heptane | 33″ | 1′18″ | not ignited | 48 |
| | Sea water | 3 | n-heptane | 35″ | 1′16″ | not ignited | 25 |
| Example 39 | Fresh water | 3 | n-heptane | 40″ | 1′42″ | not ignited | 50 |
| | Sea water | 3 | n-heptane | 39″ | 1′39″ | not ignited | 0 |
| Example 40 | Fresh water | 3 | n-heptane | 38″ | 1′40″ | not ignited | 60 |
| | Sea water | 3 | n-heptane | 38″ | 1′43″ | not ignited | 45 |

Furthermore, for polar solvents (solvents which dissolve in 100 g of water at a temperature of 20° C. in an amount of 1 g or more), a fire extinguishing test was carried out based on the method described in Notice No. 71 of the Fire Prevention and Safety Department of the Fire and Disaster Management Agency. The results are shown in Table 7, Table 8 and Table 9. A fire model [fuel: 400 L of n-heptane, combustion area: 4 m² (B-20 scale, coefficient: 1)] was used and a pre-burning time was 1 minute. Each of the undiluted solutions of fire extinguishing compositions shown in the examples was diluted 33.3 times with water and 100 liters of the resulting dilute solution was filled in a pressure container. This was foamed under a nitrogen pressure of 7 kg/cm² by passing it through a standard foaming nozzle for testing aqueous film forming foam-type fire extinguishing composition (products having passed government inspection). The spray rate was adjusted to 10 liters/min and the total spray time was adjusted to 5 minutes. The temperature of any dilute solution was adjusted to 20° C.±2° C. The time required to cover 90% of the combustion area (90% control time) which functions as an index of superiority or inferiority of the spreading rate of the foams (also functions as an index of the fuel resistance in the case of polar solvents) and the complete fire extinguishing time which represents the fire extinguishing rate most remarkably were measured, and then the vapor sealing test which functions as an index of the re-ignition preventive performance and the burnback test which functions as an index of the flame resistance were evaluated in the same manner as in the case of the evaluation test for non-polar solvents.

TABLE 7

| | | | | | 90% | | | |
|---|---|---|---|---|---|---|---|---|
| | | Dilution | | Foaming | control | Fire | Vapor | |
| | Dilution | ratio | | ratio | time | extinguishing | sealing | Burnback |
| | water | (%) | Burning solvent | (times) | (seconds) | time | test | test (cm²) |
| Example 1 | Fresh water | 3 | Isopropyl alcohol | 6.2 | 42″ | 1′51″ | not ignited | 65 |
| | Sea water | 3 | Isopropyl alcohol | 6.4 | 44″ | 1′52″ | not ignited | 70 |
| Example 2 | Fresh water | 3 | Isopropyl alcohol | 6.3 | 45″ | 1′55″ | not ignited | 68 |
| | Sea water | 3 | Isopropyl alcohol | 6.3 | 46″ | 1′53″ | not ignited | 75 |
| Example 3 | Fresh water | 3 | Methanol | 6.3 | 34″ | 1′10″ | not ignited | 10 |
| | Sea water | 3 | Methanol | 6.3 | 38″ | 1′05″ | not ignited | 15 |
| Example 4 | Fresh water | 3 | Acetone | 6.2 | 30″ | 1′21″ | not ignited | 45 |
| | Sea water | 3 | Acetone | 6.2 | 30″ | 1′25″ | not ignited | 36 |
| Example 5 | Fresh water | 3 | Acetone | 6.0 | 33″ | 1′19″ | not ignited | 33 |
| | Sea water | 3 | Acetone | 6.0 | 33″ | 1′17″ | not ignited | 31 |
| Example 6 | Fresh water | 3 | Propylene oxide | 6.1 | 29″ | 55″ | not ignited | 20 |
| | Sea water | 3 | Propylene oxide | 6.1 | 27″ | 54″ | not ignited | 26 |
| Example 7 | Fresh water | 3 | Isopropyl alcohol | 6.3 | 41″ | 1′51″ | not ignited | 75 |
| | Sea water | 3 | Isopropyl alcohol | 6.4 | 45″ | 1′48″ | not ignited | 68 |
| Example 8 | Fresh water | 3 | Acetone | 6.1 | 30″ | 1′15″ | not ignited | 20 |
| | Sea water | 3 | Acetone | 6.3 | 29″ | 1′21″ | not ignited | 18 |
| Example 9 | Fresh water | 3 | Methanol | 6.2 | 29″ | 1′08″ | not ignited | 14 |
| | Sea water | 3 | Methanol | 6.3 | 28″ | 1′02″ | not ignited | 10 |
| Example | Fresh water | 3 | Methanol | 6.1 | 30″ | 1′14″ | not ignited | 20 |
| 10 | Sea water | 3 | Methanol | 6.1 | 31″ | 1′12″ | not ignited | 33 |
| Example | Fresh water | 3 | Acetone | 6.3 | 35″ | 1′22″ | not ignited | 36 |
| 11 | Sea water | 3 | Acetone | 6.2 | 38″ | 1′17″ | not ignited | 17 |
| Example | Fresh water | 3 | Methanol | 5.9 | 26″ | 1′01″ | not ignited | 5 |
| 12 | Sea water | 3 | Methanol | 6.0 | 29″ | 1′03″ | not ignited | 14 |
| Example | Fresh water | 3 | Propylene oxide | 6.4 | 26″ | 57″ | not ignited | 20 |
| 13 | Sea water | 3 | Propylene oxide | 6.3 | 24″ | 56″ | not ignited | 26 |
| Example | Fresh water | 3 | Isopropyl alcohol | 6.2 | 39″ | 1′59″ | not ignited | 64 |
| 14 | Sea water | 3 | Isopropyl alcohol | 6.2 | 33″ | 1′44″ | not ignited | 62 |
| Example | Fresh water | 3 | Acetone | 6.0 | 39″ | 1′27″ | not ignited | 40 |
| 15 | Sea water | 3 | Acetone | 6.0 | 41″ | 1′21″ | not ignited | 39 |
| Example | Fresh water | 3 | Acetone | 6.3 | 44″ | 1′30″ | not ignited | 24 |
| 16 | Sea water | 3 | Acetone | 6.4 | 43″ | 1′35″ | not ignited | 27 |
| Example | Fresh water | 3 | Acetone | 6.1 | 37″ | 1′28″ | not ignited | 75 |
| 17 | Sea water | 3 | Acetone | 6.3 | 34″ | 1′19″ | not ignited | 66 |

TABLE 8

| | | | | | 90% | | | |
|---|---|---|---|---|---|---|---|---|
| | | Dilution | | Foaming | control | Fire | Vapor | |
| | Dilution | ratio | | ratio | time | extinguishing | sealing | Burnback |
| | water | (%) | Burning solvent | (times) | (seconds) | time | test | test (cm²) |
| Example | Fresh water | 3 | Isopropyl alcohol | 5.8 | 45″ | 2′11″ | not ignited | 76 |
| 18 | Sea water | 3 | Isopropyl alcohol | 5.7 | 47″ | 2′02″ | not ignited | 80 |
| Example | Fresh water | 3 | Acetone | 6.1 | 38″ | 1′23″ | not ignited | 33 |
| 19 | Sea water | 3 | Acetone | 6.1 | 37″ | 1′20″ | not ignited | 44 |
| Example | Fresh water | 3 | Propylene oxide | 6.1 | 24″ | 1′01″ | not ignited | 10 |
| 20 | Sea water | 3 | Propylene oxide | 6.2 | 26″ | 59″ | not ignited | 11 |
| Example | Fresh water | 3 | Acetone | 5.9 | 31″ | 1′34″ | not ignited | 32 |
| 21 | Sea water | 3 | Acetone | 6.0 | 35″ | 1′38″ | not ignited | 36 |
| Example | Fresh water | 3 | Propylene oxide | 6.2 | 24″ | 55″ | not ignited | 20 |
| 22 | Sea water | 3 | Propylene oxide | 6.2 | 23″ | 54″ | not ignited | 22 |
| Example | Fresh water | 3 | Acetone | 6.1 | 29″ | 1′22″ | not ignited | 18 |
| 23 | Sea water | 3 | Acetone | 6.1 | 28″ | 1′20″ | not ignited | 19 |
| Example | Fresh water | 3 | Isopropyl alcohol | 6.1 | 47″ | 2′02″ | not ignited | 55 |
| 24 | Sea water | 3 | Isopropyl alcohol | 6.0 | 44″ | 2′06″ | not ignited | 74 |
| Example | Fresh water | 3 | Methanol | 6.3 | 25″ | 59″ | not ignited | 10 |
| 25 | Sea water | 3 | Methanol | 6.2 | 24″ | 57″ | not ignited | 13 |
| Example | Fresh water | 3 | Acetone | 6.0 | 30″ | 1′26″ | not ignited | 33 |
| 26 | Sea water | 3 | Acetone | 6.0 | 29″ | 1′23″ | not ignited | 31 |
| Example | Fresh water | 3 | Acetone | 6.1 | 32″ | 1′25″ | not ignited | 29 |
| 27 | Sea water | 3 | Acetone | 6.1 | 33″ | 1′26″ | not ignited | 22 |
| Example | Fresh water | 3 | Methanol | 6.2 | 22″ | 58″ | not ignited | 22 |
| 28 | Sea water | 3 | Methanol | 6.2 | 23″ | 56″ | not ignited | 18 |
| Example | Fresh water | 3 | Isopropyl alcohol | 6.5 | 43″ | 1′59″ | not ignited | 80 |
| 29 | Sea water | 3 | Isopropyl alcohol | 6.3 | 46″ | 1′52″ | not ignited | 68 |
| Example | Fresh water | 3 | Acetone | 6.0 | 26″ | 1′31″ | not ignited | 40 |
| 30 | Sea water | 3 | Acetone | 6.0 | 24″ | 1′38″ | not ignited | 35 |
| Example | Fresh water | 3 | Methanol | 5.7 | 24″ | 1′29″ | not ignited | 36 |
| 31 | Sea water | 3 | Methanol | 6.1 | 28″ | 1′31″ | not ignited | 17 |
| Example | Fresh water | 3 | Acetone | 6.2 | 27″ | 1′29″ | not ignited | 34 |
| 32 | Sea water | 3 | Acetone | 6.2 | 29″ | 1′24″ | not ignited | 44 |

TABLE 9

| | | | | | 90% | | | |
|---|---|---|---|---|---|---|---|---|
| | | Dilution | | Foaming | control | Fire | Vapor | |
| | Dilution | ratio | | ratio | time | extinguishing | sealing | Burnback |
| | water | (%) | Burning solvent | (times) | (seconds) | time | test | test (cm²) |
| Example | Fresh water | 3 | Methanol | 6.0 | 27″ | 1′31″ | not ignited | 33 |
| 33 | Sea water | 3 | Methanol | 6.0 | 31″ | 1′30″ | not ignited | 32 |
| Example | Fresh water | 3 | Methanol | 5.9 | 23″ | 1′04″ | not ignited | 13 |
| 34 | Sea water | 3 | Methanol | 6.2 | 24″ | 1′07″ | not ignited | 15 |
| Example | Fresh water | 3 | Isopropyl alcohol | 6.1 | 45″ | 2′19″ | not ignited | 77 |
| 35 | Sea water | 3 | Isopropyl alcohol | 6.1 | 47″ | 2′16″ | not ignited | 69 |
| Example | Fresh water | 3 | Isopropyl alcohol | 6.2 | 44″ | 1′53″ | not ignited | 77 |
| 36 | Sea water | 3 | Isopropyl alcohol | 6.2 | 45″ | 1′57″ | not ignited | 61 |
| Example | Fresh water | 3 | Isopropyl alcohol | 6.2 | 49″ | 2′11″ | not ignited | 76 |
| 37 | Sea water | 3 | Isopropyl alcohol | 6.1 | 48″ | 2′14″ | not ignited | 71 |
| Example | Fresh water | 3 | Methanol | 6.5 | 21″ | 1′01″ | not ignited | 22 |
| 38 | Sea water | 3 | Methanol | 6.4 | 24″ | 1′09″ | not ignited | 23 |
| Example | Fresh water | 3 | Methanol | 6.3 | 26″ | 1′16″ | not ignited | 9 |
| 39 | Sea water | 3 | Methanol | 6.1 | 27″ | 1′19″ | not ignited | 6 |
| Example | Fresh water | 3 | Methanol | 6.0 | 33″ | 1′25″ | not ignited | 20 |
| 40 | Sea water | 3 | Methanol | 6.0 | 31″ | 1′24″ | not ignited | 35 |

<Test Procedure and Evaluation Criteria>

Foaming Ratio:

Foams produced by a standard foaming nozzle for testing aqueous film forming foam-type fire extinguishing composition (products having passed government inspection) were filled in a foam collecting container (volume V: 1400 [l], weight W1 [g]) stipulated in Ordinance No. 26 of the Ministry of Home Affairs of Japan and the total weight (W2 [g]) of the foam collecting container was measured when filled with the foams. The foaming ratio was determined by calculating the following formula:

$$Foaming ratio = \frac{V}{W2 - W1}$$

90% control time means the time when 90% of the combustion area of a fire model (combustion area: 4 m², B-20 scale) was covered with the foams after the initiation of discharging of the foams.

Fire Extinction Time:

Fire extinction time means the time when a flame on a fire model disappeared completely after the initiation of discharging of the foams.

Vapor Sealing Test:

For 1 minute, 7 minutes or 11 minutes after the completion of discharging, a flame was made to approach the foam surface by using a torch, and it was determined whether or not the solvent caught fire.

Burnback Test:

For 15 minutes after the completion of discharging, a hole of 225 cm² was made at the center of a model fire and, after forced ignition, the degree combustion area increased after 5 minutes was observed.

### Comparative Examples 1 to 21

In accordance with the same formulation and the same mixing method as in the Examples, except for using polyethyleneimine containing more than 40% of a primary amine and less than 35% of a secondary amine, as the characteristic cationic polyamine-based polymeric compound (A) of the present invention, or an N-propyl-substituted compound, a fire extinguishing composition (3% type undiluted solution) was mixed.

The kinds of the cationic polyamine-based polymeric compound (A), the surfactant (B) and the polybasic acid (C) as well as the appearance, the freezing point and the kinematic viscosity of the resulting fire extinguishing composition (3% type undiluted solution) and the amount of the precipitate of a 3% tap water dilute solution measured based on the technical standard described in Ordinance No. 26 of the Ministry of Home Affairs of Japan, are shown in Table 10.

Furthermore, the fire extinguishing test of thixotropic water-soluble polymeric substance-containing fire extinguishing compositions (containing a fluorine type surfactant, commercially available products) were carried out. Test results for non-polar solvents are shown in Table 11 and Table 12, while test results for polar solvents are shown in Table 13 and Table 14. The numbers in the rightmost columns in the tables means the number of the Example corresponding to the Comparative Example.

TABLE 10

| | Cationic | | | | | Kinematic | Test for |
|---|---|---|---|---|---|---|---|
| | polymeric | | | | | viscosity | amount of |
| | substance | Surfactant | Polybasic | | Freezing | at | precipitate* |
| | (A) | (B) | acid (C) | Appearance | point (° C.) | −10° C. (cst) | (vol %) |
| Comparative | A-I-3 | B-1-a | C-1 (n = 4) | Completely | −19 | 126 | 0.5 |
| Example 1 | | | | clear | | | |
| Comparative | A-I-3 | B-1-t | C-1 (n = 6) | completely | −17 | 132 | 0.5 |
| Example 2 | | | | clear | | | |
| Comparative | A-I-4 | B-1-h | C-4 | completely | −17 | 144 | 0.3 |
| Example 3 | | | | clear | | | |
| Comparative | A-I-4 | B-1-m | C-13 | completely | −16 | 119 | 0.4 |
| Example 4 | | | | clear | | | |
| Comparative | A-I-3 | B-2-a | C-23 | completely | −18 | 140 | 0.5 |
| Example 5 | | | | clear | | | |
| Comparative | A-I-3 | B-2-j | C-24 | completely | −17 | 111 | 0.6 |
| Example 6 | | | | clear | | | |
| Comparative | A-I-4 | B-2-g | C-28 | completely | −16 | 133 | 0.3 |
| Example 7 | | | | clear | | | |
| Comparative | A-I-4 | B-2-c | C-16 | completely | −17 | 129 | 0.2 |
| Example 8 | | | | clear | | | |
| Comparative | A-I-3 | B-3-I | C-17 | completely | −16 | 117 | 0.5 |
| Example 9 | | | | clear | | | |
| Comparative | A-I-3 | B-4-b | C-1 (n = 4) | completely | −19 | 118 | 0.5 |
| Example 10 | | | | clear | | | |
| Comparative | A-I-3 | B-4-g | C-14 | completely | −16 | 117 | 0.5 |
| Example 11 | | | | clear | | | |
| Comparative | A-I-3 | B-5-I | C-10 | completely | −17 | 128 | 0.4 |
| Example 12 | | | | clear | | | |
| Comparative | A-I-3 | B-6-c | C-11 | completely | −18 | 131 | 0.5 |
| Example 13 | | | | clear | | | |
| Comparative | A-I-4 | B-6-a | C-16 | completely | −16 | 122 | 0.5 |
| Example 14 | | | | clear | | | |
| Comparative | A-I-4 | B-6-e | C-3 | completely | −18 | 140 | 0.4 |
| Example 15 | | | | clear | | | |
| Comparative | A-I-4 | B-7-g | C-16 | completely | −18 | 130 | 0.3 |
| Example 16 | | | | clear | | | |
| Comparative | A-I-3 | B-8-d | C-23 | completely | −17 | 122 | 0.5 |
| Example 17 | | | | clear | | | |
| Comparative | A-I-3 | B-9-a | C-28 | completely | −18 | 149 | 0.5 |
| Example 18 | | | | clear | | | |
| Comparative | A-I-3 | B-9-1 | C-1 (n = 8) | completely | −17 | 134 | 0.4 |
| Example 19 | | | | clear | | | |
| Comparative | A-I-3 | B-10-a | C-1 (n = 4) | completely | −18 | 162 | 0.5 |
| Example 20 | | | | clear | | | |
| Comparative | A-I-3 | B-10-b | C-10 | completely | −19 | 169 | Trace |
| Example 21 | | | | clear | | | |

TABLE 11

| | | Dilution | | 90% control | Fire | | | |
|---|---|---|---|---|---|---|---|---|
| | Dilution | ratio | Burning | time | extinguishing | Vapor | Burnback | Corresponding |
| | water | (%) | solvent | (seconds) | time | sealing test | test (cm²) | Example |
| Comparative | Fresh water | 3 | n-heptane | 46″ | 1′55″ | not ignited | 100 | 1 |
| Example 1 | Sea water | 3 | n-heptane | 50″ | 2′07″ | not ignited | 97 | |
| Comparative | Fresh water | 3 | n-heptane | 44″ | 1′59″ | not ignited | 50 | 3 |
| Example 2 | Sea water | 3 | n-heptane | 45″ | 2′15″ | not ignited | 120 | |
| Comparative | Fresh water | 3 | n-heptane | 50″ | 2′11″ | not ignited | 100 | 5 |
| Example 3 | Sea water | 3 | n-heptane | 48″ | 2′13″ | not ignited | 122 | |
| Comparative | Fresh water | 3 | n-heptane | 41″ | 1′48″ | not ignited | 90 | 7 |
| Example 4 | Sea water | 3 | n-heptane | 43″ | 2′05″ | not ignited | 80 | |
| Comparative | Fresh water | 3 | n-heptane | 39″ | 2′30″ | not ignited | 90 | 9 |
| Example 5 | Sea water | 3 | n-heptane | 44″ | 2′57″ | not ignited | 154 | |
| Comparative | Fresh water | 3 | n-heptane | 50″ | 2′44″ | not ignited | 99 | 11 |
| Example 6 | Sea water | 3 | n-heptane | 47″ | 2′52″ | not ignited | 112 | |
| Comparative | Fresh water | 3 | n-heptane | 45″ | 2′36″ | not ignited | 130 | 13 |
| Example 7 | Sea water | 3 | n-heptane | 43″ | 2′48″ | not ignited | 140 | |
| Comparative | Fresh water | 3 | n-heptane | 42″ | 2′09″ | not ignited | 100 | 15 |
| Example 8 | Sea water | 3 | n-heptane | 44″ | 2′26″ | not ignited | 122 | |
| Comparative | Fresh water | 3 | n-heptane | 53″ | 2′33″ | not ignited | 166 | 17 |
| Example 9 | Sea water | 3 | n-heptane | 55″ | 2′56″ | not ignited | 177 | |
| Comparative | Fresh water | 3 | n-heptane | 38″ | 2′11″ | not ignited | 188 | 19 |
| Example 10 | Sea water | 3 | n-heptane | 40″ | 2′28″ | not ignited | 130 | |
| Comparative | Fresh water | 3 | n-heptane | 42″ | 2′00″ | not ignited | 98 | 21 |
| Example 11 | Sea water | 3 | n-heptane | 41″ | 2′05″ | not ignited | 70 | |
| Comparative | Fresh water | 3 | n-heptane | 42″ | 2′22″ | not ignited | 120 | 23 |
| Example 12 | Sea water | 3 | n-heptane | 45″ | 2′24″ | not ignited | 129 | |
| Comparative | Fresh water | 3 | n-heptane | 37″ | 1′54″ | not ignited | 189 | 25 |
| Example 13 | Sea water | 3 | n-heptane | 38″ | 1′55″ | not ignited | 150 | |
| Comparative | Fresh water | 3 | n-heptane | 46″ | 2′44″ | not ignited | 123 | 27 |
| Example 14 | Sea water | 3 | n-heptane | 48″ | 2′32″ | not ignited | 144 | |
| Comparative | Fresh water | 3 | n-heptane | 43″ | 2′33″ | not ignited | 118 | 29 |
| Example 15 | Sea water | 3 | n-heptane | 42″ | 2′40″ | not ignited | 150 | |
| Comparative | Fresh water | 3 | n-heptane | 49″ | 3′00″ | not ignited | 200 | 31 |
| Example 16 | Sea water | 3 | n-heptane | 46″ | 3′17″ | not ignited | 120 | |
| Comparative | Fresh water | 3 | n-heptane | 43″ | 2′22″ | not ignited | 120 | 33 |
| Example 17 | Sea water | 3 | n-heptane | 48″ | 2′37″ | not ignited | 102 | |

TABLE 12

| | | | | 90% | Fire | | | |
|---|---|---|---|---|---|---|---|---|
| | | Dilution | | control | extin- | Vapor | Burnback | |
| | Dilution | ratio | Burning | time | guishing | sealing | test | Corresponding |
| | water | (%) | solvent | (seconds) | time | test | (cm²) | Example |
| Comparative | Fresh water | 3 | n-heptane | 45″ | 2′21″ | not ignited | 111 | 35 |
| Example 18 | Sea water | 3 | n-heptane | 47″ | 2′29″ | not ignited | 122 | |
| Comparative | Fresh water | 3 | n-heptane | 39″ | 2′43″ | not ignited | 167 | 37 |
| Example 19 | Sea water | 3 | n-heptane | 40″ | 2′54″ | not ignited | 155 | |
| Comparative | Fresh water | 3 | n-heptane | 59″ | 3′01″ | not ignited | 180 | 39 |
| Example 20 | Sea water | 3 | n-heptane | 53″ | 3′11″ | not ignited | 168 | |
| Comparative | Fresh water | 3 | n-heptane | 1′11″ | 4′13″ | not ignited | 235 | |
| Example 21 | Sea water | 3 | n-heptane | 1′17″ | 4′43″ | not ignited | 250 | |
| (commercially | | | | | | | | |
| available | | | | | | | | |
| product) | | | | | | | | |

TABLE 13

| | | | | | 90% | Fire | | | |
|---|---|---|---|---|---|---|---|---|---|
| | | Dilution | | Foaming | control | extin- | Vapor | Burnback | |
| | Dilution | ratio | | ratio | time | guishing | sealing | test | Corresponding |
| | water | (%) | Burning solvent | (times) | (seconds) | time | test | (cm²) | Example |
| Comparative | Fresh water | 3 | Isopropyl alcohol | 6.3 | 56″ | 2′51″ | not ignited | 211 | 1 |
| Example 1 | Sea water | 3 | Isopropyl alcohol | 6.1 | 59″ | 3′07″ | not ignited | 153 | |
| Comparative | Fresh water | 3 | Methanol | 6.2 | 45″ | 1′54″ | not ignited | 95 | 3 |
| Example 2 | Sea water | 3 | Methanol | 6.3 | 44″ | 1′58″ | not ignited | 75 | |
| Comparative | Fresh water | 3 | Acetone | 5.9 | 50″ | 2′17″ | not ignited | 100 | 5 |
| Example 3 | Sea water | 3 | Acetone | 6.1 | 51″ | 2′22″ | not ignited | 90 | |
| Comparative | Fresh water | 3 | Isopropyl alcohol | 6.2 | 1′06″ | 3′25″ | not ignited | 185 | 7 |
| Example 4 | Sea water | 3 | Isopropyl alcohol | 6.2 | 1′10″ | 3′14″ | not ignited | 154 | |
| Comparative | Fresh water | 3 | Methanol | 6.2 | 47″ | 2′15″ | not ignited | 99 | 9 |
| Example 5 | Sea water | 3 | Methanol | 6.3 | 46″ | 2′03″ | not ignited | 77 | |
| Comparative | Fresh water | 3 | Acetone | 6.3 | 52″ | 2′23″ | not ignited | 112 | 11 |
| Example 6 | Sea water | 3 | Acetone | 6.3 | 51″ | 2′13″ | not ignited | 123 | |
| Comparative | Fresh water | 3 | Propylene oxide | 6.3 | 41″ | 2′06″ | not ignited | 95 | 13 |
| Example 7 | Sea water | 3 | Propylene oxide | 6.3 | 42″ | 2′07″ | not ignited | 90 | |
| Comparative | Fresh water | 3 | Acetone | 6.1 | 50″ | 2′22″ | not ignited | 123 | 15 |
| Example 8 | Sea water | 3 | Acetone | 6.2 | 49″ | 2′43″ | not ignited | 115 | |
| Comparative | Fresh water | 3 | Acetone | 6.0 | 49″ | 2′58″ | not ignited | 203 | 17 |
| Example 9 | Sea water | 3 | Acetone | 6.1 | 50″ | 3′13″ | not ignited | 177 | |
| Comparative | Fresh water | 3 | Acetone | 6.0 | 51″ | 2′15″ | not ignited | 180 | 19 |
| Example 10 | Sea water | 3 | Acetone | 6.1 | 52″ | 2′11″ | not ignited | 175 | |
| Comparative | Fresh water | 3 | Acetone | 6.1 | 46″ | 2′22″ | not ignited | 235 | 21 |
| Example 11 | Sea water | 3 | Acetone | 6.0 | 48″ | 2′19″ | not ignited | 201 | |
| Comparative | Fresh water | 3 | Acetone | 6.0 | 44″ | 2′21″ | not ignited | 154 | 23 |
| Example 12 | Sea water | 3 | Acetone | 6.0 | 43″ | 2′44″ | not ignited | 132 | |
| Comparative | Fresh water | 3 | Methanol | 6.2 | 40″ | 1′46″ | not ignited | 94 | 25 |
| Example 13 | Sea water | 3 | Methanol | 6.1 | 41″ | 1′55″ | not ignited | 88 | |
| Comparative | Fresh water | 3 | Acetone | 6.0 | 45″ | 2′19″ | not ignited | 120 | 27 |
| Example 14 | Sea water | 3 | Acetone | 6.0 | 43″ | 2′15″ | not ignited | 115 | |
| Comparative | Fresh water | 3 | Isopropyl alcohol | 6.3 | 53″ | 3′01″ | not ignited | 200 | 29 |
| Example 15 | Sea water | 3 | Isopropyl alcohol | 6.3 | 57″ | 2′50″ | not ignited | 185 | |
| Comparative | Fresh water | 3 | Methanol | 5.9 | 40″ | 3′20″ | not ignited | 160 | 31 |
| Example 16 | Sea water | 3 | Methanol | 6.0 | 39″ | 3′36″ | not ignited | 144 | |

TABLE 14

| | | | | | 90% | Fire | | | |
|---|---|---|---|---|---|---|---|---|---|
| | | Dilution | | Foaming | control | extin- | Vapor | Burnback | |
| | Dilution | ratio | | ratio | time | guishing | sealing | test | Corresponding |
| | water | (%) | Burning solvent | (times) | (seconds) | time | test | (cm²) | Example |
| Comparative | Fresh water | 3 | Methanol | 5.9 | 41″ | 2′29″ | not ignited | 120 | 33 |
| Example 17 | Sea water | 3 | Methanol | 6.0 | 43″ | 2′26″ | not ignited | 109 | |
| Comparative | Fresh water | 3 | Isopropyl alcohol | 6.1 | 1′01″ | 3′22″ | not ignited | 277 | 35 |
| Example 18 | Sea water | 3 | Isopropyl alcohol | 6.0 | 58″ | 3′20″ | not ignited | 255 | |
| Comparative | Fresh water | 3 | Isopropyl alcohol | 6.3 | 58″ | 3′00″ | not ignited | 188 | 37 |
| Example 19 | Sea water | 3 | Isopropyl alcohol | 6.3 | 55″ | 2′11″ | not ignited | 164 | |
| Comparative | Fresh water | 3 | Methanol | 6.2 | 37″ | 2′54″ | not ignited | 70 | 39 |
| Example 20 | Sea water | 3 | Methanol | 6.2 | 37″ | 2′49″ | not ignited | 65 | |
| Comparative | Fresh water | 3 | Isopropyl alcohol | 6.2 | 1′20″ | fire not | not carried | not | — |
| Example 21 | | | | | | extin- | out | carried | |
| (commercially | | | | | | guished | | out | |
| available not | Sea water | 3 | Isopropyl alcohol | 6.0 | 1′18″ | fire not | not carried | not | |
| product) | | | | | | extin- | out | carried | |
| | | | | | | guished | | out | |

### INDUSTRIAL APPLICABILITY

The fire extinguishing composition of the present invention can produce very stable foams on polar solvents and form an aqueous film against fire of non-polar solvents such as petroleums, and also has markedly improved rapid fire extinguishing performance, re-ignition preventive performance, flame resistance and fuel resistance.

1. A fire extinguishing composition comprising a cationic polyamine-based polymeric compound (A), wherein a viscosity at 25° C. of an aqueous solution containing 50% by weight of the cationic polyamine-based polymeric compound (A) is from 10,000 to 30,000 mPa·s.

2. The fire extinguishing composition according to claim 1, which contains an anionic hydrophilic group-containing surfactant (B).

3. The fire extinguishing composition according to claim 1 or 2, which contains a polybasic acid compound (C).

4. The fire extinguishing composition according to any one of claims 1 to 3, wherein the cationic polyamine-based polymeric compound (A) is polyethyleneimine or a derivative thereof.

5. The fire extinguishing composition according to any one of claims 1 to 4, wherein the polybasic acid compound (C) is a dibasic acid compound having 4 to 18 carbon atoms.

6. The fire extinguishing composition according to any one of claims 1 to 5, wherein the anionic hydrophilic group-containing surfactant (B) is a fluorine-containing type surfactant having a fluorinated aliphatic group having 3 to 20 carbon atoms as a hydrophobic group.
